(19) United States
(12) Patent Application Publication
(10) Pub. No.: US 2007/0150325 A1
(43) Pub. Date: Jun. 28, 2007

(54) Resource management system

(76) Inventor: Carl C. Bjornson, Tiverton, RI (US)

Correspondence Address: Kenneth P. Robinson, PO Box 328, Greenlawn, NY, 11740-0328, US

(21) Appl. No.: 11/636,851

(22) Filed: Dec. 11, 2006

Related U.S. Application Data
(63) Continuation of application No. 09/643,976, filed on Aug. 22, 2000, now abandoned.
(60) Provisional application No. 60/208,186, filed on May 31, 2000.

(51) Int. Cl. G06F 9/44

(52) U.S. Cl. 705/7

(57) ABSTRACT

A resource management system identifies, tracks and corrects deficiencies in resources and predictions, decisions and actions in connection with buying, using operation and sale of human, operating and manufacturing resources in an enterprise. This allows the specification of the best solution for a specific application based on constraints, such as goals and objectives, and resources available in the enterprise. Combinations of resources of interest are assigned a deficiency cost, e.g., in terms of decreased life, increased costs, etc. relative to a best in class combination or other solution. These combinations and associated costs are stored in a database. Each combination generally has one or more identified deficiencies and one or more corresponding corrective actions. Given a specification of the actual system in use, a cost of that system, relative to a best in class system or optimal solution given specified constraints, and corrective actions may be retrieved from the database.

### CROSS-REFERENCE TO RELATED APPLICATIONS

This application is a continuation of application Ser. No. 09/643,976, filed Aug. 22, 2000, which claimed priority under 35 U.S.C. §119(e) to provisional application Ser. No. 60/208,186, filed May 31, 2000, which is hereby incorporated by reference.

This application also is related to both U.S. patent application Ser. No. 09/179,506, filed on Oct. 17, 1998, now U.S. Pat. No. 6,173,210, hereinafter “the ESP application” (which is a continuation of U.S. patent application Ser. No. 09/033,194, filed Mar. 2, 1998, now abandoned), and U.S. patent application Ser. No. 09/255,511, filed Feb. 22, 1999, now U.S. Pat. No. 6,505,145 hereinafter “the Plant Reliability application,” which are hereby incorporated by reference.

### BACKGROUND

Many systems have been proposed and/or are under development to enable electronic commerce, and particularly to enable electronic processing of transactions for both business-to-business and business-to-consumer transactions. Such systems generally focus on providing a significant reduction in the cost of procurement of goods. Such cost reductions are achieved by having automatic and paperless transactions replace manual and paper based transactions which are prone to error. Also, such cost reductions may be achieved by creating electronic marketplaces, such as auctions, to enable multiple vendors and multiple buyers to compete in the marketplace for goods and services.

These systems often assume that a purchaser of a good or service has accurately and completely specified the good or service which is desired, and has determined which good or service would be best. Thus, purchasers of goods and services tend to simply repurchase goods and services that have been purchased in the past, particularly when purchasing equipment for maintenance, repairs, and operation of a plant. By continuing to purchase the same equipment, purchasers cannot achieve cost savings that may be provided by identifying and purchasing better equipment.

### SUMMARY

In some industries, cost savings that may be introduced by improving the selection, buying, use, operation and sale of all resources, in alignment with corporate goals, dwarfs the potential cost savings that may be provided merely by automating transactions for the procurement of goods and services. The present invention provides a mechanism through which cost benefits may be obtained by identifying, tracking and correcting deficiencies in resources and predictions, decisions and actions in connection with buying, using, operation and sale of human, operating and manufacturing resources in an enterprise. Such a mechanism allows the specification of the best solution for a specific application based on constraints, such as goals and objectives, and resources available in the enterprise. This mechanism specifies a “best-in-class” solution or an optimal solution given certain constraints. Other possible solutions are specified in terms of their deficiencies with respect to this solution. Costs are associated with these deficiencies in terms of either decreased life or other costs incurred. Such costs may be precomputed and stored in the system for as many possible solutions. By combining actual data about actual resources with the predicted costs for the optimal solution, costs for nonoptimal solutions are identified, and may be associated with corrective actions. By storing all of this information in a database that links a possible solution to its costs, entering of the actual data about actual resources can automatically provide a measure of the cost of the nonoptimal solution.

All possible combinations of resources of interest are assigned a cost, e.g., in terms of decreased life, increased costs, etc. with respect to a best in class combination or other solution. These combinations and associated costs are stored in a database. Each combination generally has one or more identified deficiencies and one or more corresponding corrective actions. The actual combination in use is specified by inputs to the system, including but not limited to enterprise resource planning systems, other systems for manufacturing and automation, inputs from front line workers who enter data in checklists and data entry forms. Given a specification of the actual system in use, a cost of that system, with respect to a best in class system or optimal solution given specified constraints, and corrective actions may be retrieved from the database.

By tracking how the actual combinations arise in the enterprise, as the result of decisions, predictions and actions, etc., accountability can be assigned. To track accountability, the system, in part, stores known suboptimal combinations and assigns accountability to entities that implement these combinations. Also all predictions, decisions and actions made using this system are tracked to allow for accountability when a deficient prediction, decision or action is made. Accordingly, in one aspect, a resource management system includes a resource characteristic database. In the resource characteristic database, for each of a plurality of resources, a skill level required for the resource is stored. In one embodiment, an enterprise resource database may include, for each of a plurality of human resources in the enterprise, a skill level of the human resource. In another embodiment, in the resource characteristic database, for each of the plurality of resources, information about attributes of the resource may be stored. In another embodiment, in the enterprise resource database, for each of a plurality of resources in the enterprise, actual characteristics of the resource may be stored. The actual characteristics may be defined as one of machine inputs or inputs defining what an operator sees, measures, hears, smells, tastes or touches.

In another aspect, a resource management system may include an enterprise resource database. In the enterprise resource database, for each of a plurality of resources in the enterprise, actual characteristics of the resource may be stored. The actual characteristics may be defined as one of machine inputs or inputs defining what an operator sees, hears, smells, tastes or touches. In another embodiment, in the resource characteristic database, for each of the plurality of resources, information about attributes of the resource may be stored.

In another aspect, a resource management system includes an enterprise resource database for storing information about resources being used in an enterprise. A deficiency database stores information regarding interactions among resources and known deficiencies related to the resources and the interactions among the resources. Deficiencies related to the resources being used in the enterprise are identified from the database. In one embodiment, an indication of estimated life of a resource being used in an enterprise is received. The deficiency database includes, for each deficiency of each resource, a cost impact of the deficiency. An efficiency analyzer uses the cost impact of the deficiency from the deficiency database and estimated life of the resource to determine whether the use of the resource meets defined constraints. In another embodiment, an enterprise performance database includes information about entities and predictions, decisions and actions made by the entities. An accountability assignor, given an indication of a deficiency, identifies, using the enterprise performance database, one of the entities that made a prediction, decision or action that resulted in the deficiency. In another embodiment, the deficiency database includes for each resource a specification of a life associated with each of one or more deficiencies related to the resource. A resource life estimator, given an indication of a deficiency related to a resource, identifies a life for the resource associated with the deficiency from the deficiency database. In another embodiment, the deficiency database includes for each resource a specification of one or more failure modes associated with each of one or more deficiencies related to the resource. A failure mode predictor, given an indication of a deficiency related to a resource, identifies a failure mode associated with the deficiency from the deficiency database. In another embodiment, the deficiency database includes, for each resource, display information about a failure mode corresponding to the deficiency. A user may be prompted for selection, using the display information from the deficiency database, to identify a failure mode of the resource in response to a failure of the resource. In another embodiment, the deficiency database that stores an indication of a failure mode corresponding to a deficiency for each resource. An indication of a failure mode of a resource may be received. A deficiency identifier identifies one or more deficiencies in the resource related to the indicated failure mode using the deficiency database. In another embodiment, the deficiency database stores information about one or more corrective actions associated with each deficiency of each resource. An indication of a deficiency of a resource is received. The corrective action associated with the deficiency of the resource is accessed from the deficiency database. In another embodiment, a life cycle cost analyzer computes a life cycle cost corresponding to the deficiency identified. In another embodiment, a database stores competitive pricing information about the resource and for storing information regarding cost structure of a purchaser of a resource. A price for the resource may be identified from the database using the stored cost information and stored pricing information. In another embodiment, a pricing analyzer has an input for receiving information describing a desired resource, and accesses the enterprise resource database to retrieve information about suppliers for the resource, and has an output for providing an indication of a price and supplier for the resource. In these embodiments, results may be generated according to specified constraints, such as goals and objectives, of an enterprise. Results may be automatically changed according to changes in the enterprise resources or in the specified constraints of the enterprise.

In another aspect, a resource management system includes a deficiency database for storing information regarding interactions among resources and known deficiencies related to the interactions. A specification of resources being used in an enterprise is received. Deficiencies related to the specified resources are identified from the database.

In another aspect, a resource management system receives an indication of a failure mode of a resource. A deficiency database stores an indication of a deficiency associated with a failure mode for each of a plurality of resources. A deficiency identifier identifies one or more deficiencies in the resource related to the indicated failure mode using the deficiency database. In one embodiment, the failure mode is an estimated failure mode. In another embodiment, the failure mode is an actual cause of failure. The resource may be an operating resource, a human resource, or a manufacturing resource. In one embodiment, the deficiency database includes for each resource a specification of a life associated with each of one or more deficiencies related to the resource. A resource life estimator, given an indication of a deficiency related to a resource, identifies a life for the resource associated with the deficiency from the deficiency database. In another embodiment, a life cycle cost analyzer computes a life cycle cost corresponding to the deficiency identified. In another embodiment, the deficiency database includes, for each deficiency of each resource, a cost impact of the deficiency. An indication of estimated life of a resource being used in an enterprise is received. An efficiency analyzer uses the cost impact of the deficiency from the deficiency database and estimated life of the resource to determine whether the use of the resource meets defined constraints.

In another aspect, a resource management system includes a deficiency database for storing information about a plurality of resources, including information about one or more corrective actions associated with each deficiency of each of the plurality of resources. An indication of a deficiency of a resource is received. The corrective action associated with the deficiency of the resource is accessed from the deficiency database.

In another aspect, a resource management system includes an enterprise performance database including information about entities and predictions, decisions and actions made by the entities. An accountability assignor, given an indication of a deficiency, identifies, using the enterprise performance database, one of the entities that made a prediction, decision or action that resulted in the deficiency.

In another aspect, a resource management system receives an indication of estimated life of a resource being used in an enterprise. A deficiency database includes, for each deficiency of each resource, a cost impact of the deficiency. An efficiency analyzer uses the cost impact of the deficiency from the deficiency database and estimated life of the resource to determine whether the use of the resource meets defined constraints. In one embodiment, an enterprise performance database includes information about entities and predictions, decisions and actions made by the entities. An accountability assignor, given an indication of a deficiency, identifies, using the enterprise performance database, one of the entities that made a prediction, decision or action that resulted in the deficiency.

In another aspect, a resource management system includes a deficiency database including for each of a plurality of resources a specification of one or more failure modes associated with each of one or more deficiencies related to the resource. A failure mode predictor, given an indication of a deficiency related to a resource, identifies a failure mode associated with the deficiency from the deficiency database.

In another aspect, a resource management system includes a deficiency database including for each of a plurality of resources a specification of a life associated with each of one or more deficiencies related to the resource. A resource life estimator, given an indication of a deficiency related to a resource, identifies a life for the resource associated with the deficiency from the deficiency database. In one embodiment, a failure mode predictor, given an indication of a deficiency related to a resource, identifies a failure mode associated with the deficiency from the deficiency database.

In another aspect, a resource management system includes a deficiency database including, for each of a plurality of resources, information for each resource about one or more deficiencies and corresponding display information about a failure mode corresponding to the deficiency. A user is prompted for selection, using the display information from the deficiency database, to identify a failure mode of the resource in response to a failure of the resource. In one embodiment, a database stores information describing a predicted life and a predicted failure mode of a resource. An actual failure mode and actual life of a resource are compared to the predicted life and predicted failure mode of the resource. In one embodiment, the deficiency database stores an indication of a deficiency associated with a failure mode for each of a plurality of resources. An indication of a failure mode of a resource is received. A deficiency identifier identifies one or more deficiencies in the resource related to the indicated failure mode using the deficiency database. In another embodiment, the deficiency database stores information about one or more corrective actions associated with each deficiency of each resource. An indication of a deficiency of a resource is received. The corrective action associated with the deficiency of the resource is accessed from the deficiency database. In another embodiment, an enterprise performance database includes information about entities and predictions, decisions and actions made by the entities. An accountability assignor, given an indication of a deficiency, identifies, using the enterprise performance database, one of the entities that made a prediction, decision or action that resulted in the deficiency. In another embodiment, a life cycle cost analyzer computes a life cycle cost corresponding to the deficiency identified.

In another aspect, a resource management system includes an enterprise resource database that stores information describing resources in an enterprise. A description of goals and objectives is received. An ideal combination of resources for meeting the described goals and objectives is determined using the enterprise resource database.

In another aspect, a resource management system includes an enterprise resource database. A pricing analyzer has an input for receiving information describing a desired resource, and accesses the enterprise resource database to retrieve information about suppliers for the resource, and has an output for providing an indication of a price and supplier for the resource.

In another aspect, a system for providing customized engineered products receives an indication of resources with which the engineered product is to interact. The engineering product is specified to be compatible with the identified resources. The engineered product is then manufactured as specified.

In another aspect, a system for providing specific installation and operating instructions for an engineered product includes a database for storing a specific installation and operating instruction variant for each variant of the engineered product. A specification for the engineered product is received. The database is accessed to retrieve the specific installation and operating instruction for the specified engineered product. In one embodiment, the database further includes a corrective action associated with a deficiency in the specification of the engineered product. The installation and operating instructions for the specified engineered product include the corrective action.

In another aspect, a system for managing resources includes a database for storing information describing deficiencies of a supplier of resources. An indication of a desired resource is received. The ability of the supplier to provide the desired resource is determined from the database according to the described deficiencies.

In another aspect, a system for managing sales of a resource includes a database for storing competitive pricing information about the resource and for storing information regarding cost structure of a purchaser of a resource. A price for the resource is determined from the database using the stored cost information and stored pricing information.

In another aspect, an information service system includes a resource characteristic database for storing information describing one or more attributes of a plurality of resources. An actual resource database stores information about resources in use in one or more enterprises. A performance database stores information about performance of the resources in use. A deficiency database stores information describing one or more deficiencies of the plurality of resources in the resource characteristic database. Multiple entities are enabled to access the databases. In one embodiment, the deficiency database includes, for each resource, display information about a failure mode corresponding to the deficiency. A user from one of the multiple entities is prompted for selection, using the display information from the deficiency database, to identify a failure mode of the resource in response to a failure of the resource. In another embodiment, the deficiency database stores an indication of a failure mode corresponding to a deficiency for each resource. An indication of a failure mode of a resource is received. A deficiency identifier identifies one or more deficiencies in the resource related to the indicated failure mode using the deficiency database. In another embodiment, the deficiency database stores information about one or more corrective actions associated with each deficiency of each resource. An indication of a deficiency of a resource is received. The corrective action associated with the deficiency of the resource is accessed from the deficiency database. In another embodiment, an enterprise performance database includes information about entities and predictions, decisions and actions made by the entities. An accountability assignor, given an indication of a deficiency, identifies, using the enterprise performance database, one of the entities that made a prediction, decision or action that resulted in the deficiency. In another embodiment, a life cycle cost analyzer computes a life cycle cost corresponding to the deficiency identified.

In another aspect, a resource management system includes a database for storing information describing each of a plurality of resources, and information describing deficiencies in each of the resources and deficiencies arising from interactions among the plurality of resources. A selection of a combination of resources is allowed. Deficiencies in the selected combination of resources are indicated and changes in resources are suggested to remove one or more deficiencies. In one embodiment, a compatibility analyzer is coupled to the resource characteristic database, the compatibility analyzer having an input that receives the data indicative of a characteristic of a first resource for comparison of a characteristic of a second resource, to determine a modification which, when made to one of the first resource and the second, allows the first resource to be compatible with the second resource. In another embodiment, data indicative of a characteristic of a first resource is provided from the resource characteristic database for comparison of a characteristic of a second resource. An indication of a modification is received which, when made to one of the first resource and the second, allows the first resource to be compatible with the second resource.

In another aspect, a human resource management system includes a resource characteristic database including for each resource, a required skill level for the resource. An enterprise resource database includes, for each resource, an associated human resource, and for each human resource, a skill level. Deficiencies in the association of human resources with resources and associated corrective actions are indicated.

In another aspect, a purchasing system includes a failure analyzer that presents an individual with possible causes of failure of a resource and associated corrective actions, wherein a corrective action includes a purchase of a resource. In response to selection of a cause of failure, a purchase transaction for the resource is initiated.

In another aspect, a process for building a resource management system includes creating a database including a solution defined as a combination of resources and information regarding deficiencies of other resources with respect to the solution. During use of the resource management system, information about resources being used is added to the database, including deficiencies of the resources with respect to the solution.

In another aspect, a resource management system includes a database for storing information describing each of a plurality of resources, and information describing deficiencies in each of the resources and deficiencies arising from interactions among the plurality of resources. A selection of a combination of resources is allowed. Deficiencies in predictions, decisions and/or actions related to the selected combination of resources are indicated.

In another aspect, a resource management system includes a failure analyzer that presents an individual with possible causes of failure of a resource and associated corrective actions, wherein a corrective action includes an action related to the resource. In response to selection of a cause of failure, the action related to the resource is initiated. In one embodiment, the action comprises defining a specification of a product. In another embodiment, the action comprises generation of engineered installation and operating instructions. It should be understood that the foregoing aspects are not limiting of the present invention. The process performed by such systems, a computer program product including computer readable media storing computer programs for performing such processes, the various databases, both individually and in combination, and the various aspects, both individually and in combination, are all aspects of the present invention.

### BRIEF DESCRIPTION OF THE DRAWING

FIG. 1 is a block diagram of an example resource management system;

FIGS. 2A-B are charts illustrating example data in a user database L;

FIG. 3 is a chart illustrating example data in a deficiency database M;

FIG. 4 is a chart illustrating example data in a deficiency database M;

FIGS. 5A-B are charts illustrating example data in a deficiency database M;

FIG. 6 is a chart illustrating example data in a deficiency database M;

FIGS. 7A-F are a chart illustrating example data in a deficiency database M;

FIG. 8 is a chart illustrating example data in a resource characteristic database N;

FIG. 9 is a chart illustrating example data in a resource characteristic database N;

FIG. 10 is a chart illustrating example data in a resource characteristic database N;

FIGS. 11A-B are a chart illustrating example data in an enterprise resource database O;

FIGS. 12A-L are a chart illustrating example data in an enterprise resource database O;

FIG. 13 is a chart illustrating example data in an enterprise resource database O;

FIGS. 14A-B are a chart illustrating example data in an enterprise performance database P;

FIG. 15 illustrates the interrelationship of FIGS. 16A-F;

FIGS. 16A-F are a data flow diagram illustrating an example resource management system;

FIG. 17 is a flow chart describing an example purchasing process for a resource; and

FIG. 18 is a chart illustrating an example determination of product life and expected failure mode.

### DETAILED DESCRIPTION

An enterprise uses various resources. These resources generally include human, manufacturing and operating resources, including products and services. The resources used by an enterprise can be grouped into various resource groups based on their function within the enterprise.

For example, a human resource group may include human resources used in the enterprise and products and services used to manage those resources. Human resources include contractors and employees acting in various capacities to make decisions, take actions and make predictions involving the enterprise. They include maintenance staff, machine operators, cleaners, supervisors, managers, etc. Products and services for managing those human resources include payroll systems, benefit plans, etc.

A manufacturing resource group includes manufacturing resources used as raw materials in manufacturing of goods or provision of services. In the case of a steel manufacturing plant, for example, a manufacturing resource includes raw materials such as steel, and water. In the case of a newspaper, for example, the manufacturing resource group includes raw news reports received from news wire services.

An operating resource group includes the operating resources used by the enterprise to convert manufacturing resources into goods or services. For a manufacturing plant, for example, the operating resource group includes pieces of rotating equipment such as pumps and seals, and physical facilities such as factory building. For a newspaper, the operating resource group includes, for example, equipment used by reporters who produce the news articles.

Every resource has a set of characteristics. These characteristics include specified features and actual features of the resource (e.g., a specified dimension vs. the actual dimension of a part) and generic information such as a type of the resource (e.g., is a mechanical seal a component seal or a cartridge seal). A resource also may have a rating, such as a skill level for a human resource or a required skill level of an individual for interacting with the resource.

A resource also affects other resources in an enterprise, and is affected by other resources. For example, a maintenance person's skill level can affect operation of equipment for which he or she is responsible. In addition, the quality of training provided to a worker by a supervisor affects the worker's skill level. A mechanical seal affects operation of a pump to which it is connected, safety of the staff who work nearby, and operation of downstream equipment. A mechanical seal also is affected by chemicals being pumped, quality of the pump to which it is attached, and workmanship with which it was installed. Thus, the performance of any resource, and thus the enterprise, not only depends on the quality of the resource and its own characteristics but also on the manner in which the resource interacts with other resources in the enterprise.

A deficiency in a resource is anything that is less than a best performance for a resource. If an attribute or characteristic is not as desirable as another attribute or characteristic for a given resource, then the one attribute or characteristic is deficient as compared to the other. Also, a deficiency may be relative to a best-in-class resource or relative to a goal or objective of an enterprise. A deficiency also may arise in a prediction, decision or action of an individual. Performance of an enterprise is improved by identifying, tracking and correcting deficiencies in resources and predictions, decisions and actions in connection with the buying, using, operation and sale of human, operating and manufacturing resources in an enterprise.

There are many types of deficiencies. First, there are those deficiencies which are inherent to a resource, irrespective of the manner in which the resource interacts with other resources in the enterprise. For a product, such a deficiency may be an inferior design, inferior manufacturing or construction, inferior quality assurance during construction, or inferior material used in the product. Such a deficiency also may be a deficiency in acquisition and disposal of the product, for example, from purchasing of the product from resellers, which mark up the price of the product or extra cost involved with disposing of the product because of environmental hazard. Such a deficiency also may be inherent in a repaired or rebuilt product.

Second, there are those deficiencies which arise because of the manner in which the resource interacts with other resources in the enterprise. In the case of a mechanical seal, for example, such a deficiency may arise from using the seal in a situation where the seal is in contact with corrosive liquids which are not compatible with the materials of construction of the seal. Such a deficiency may also arise from the quality of maintenance performed on the seal, for example, because of low skill or knowledge level of workers.

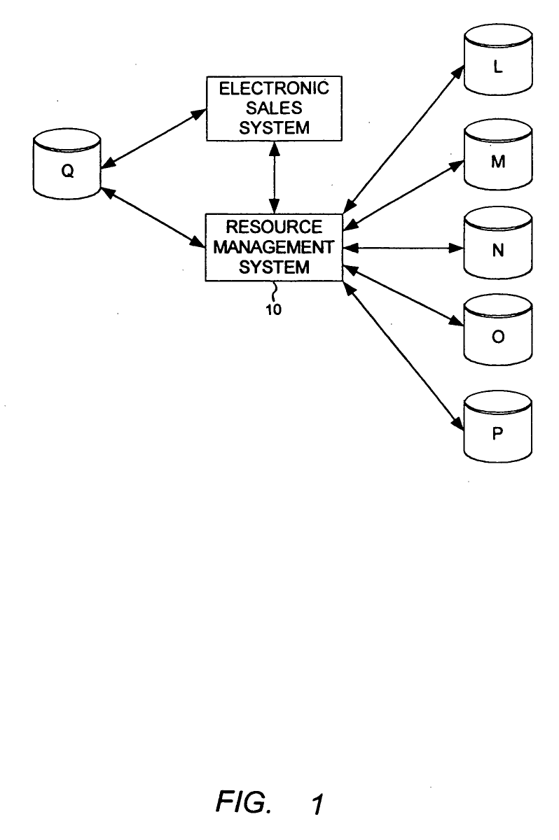

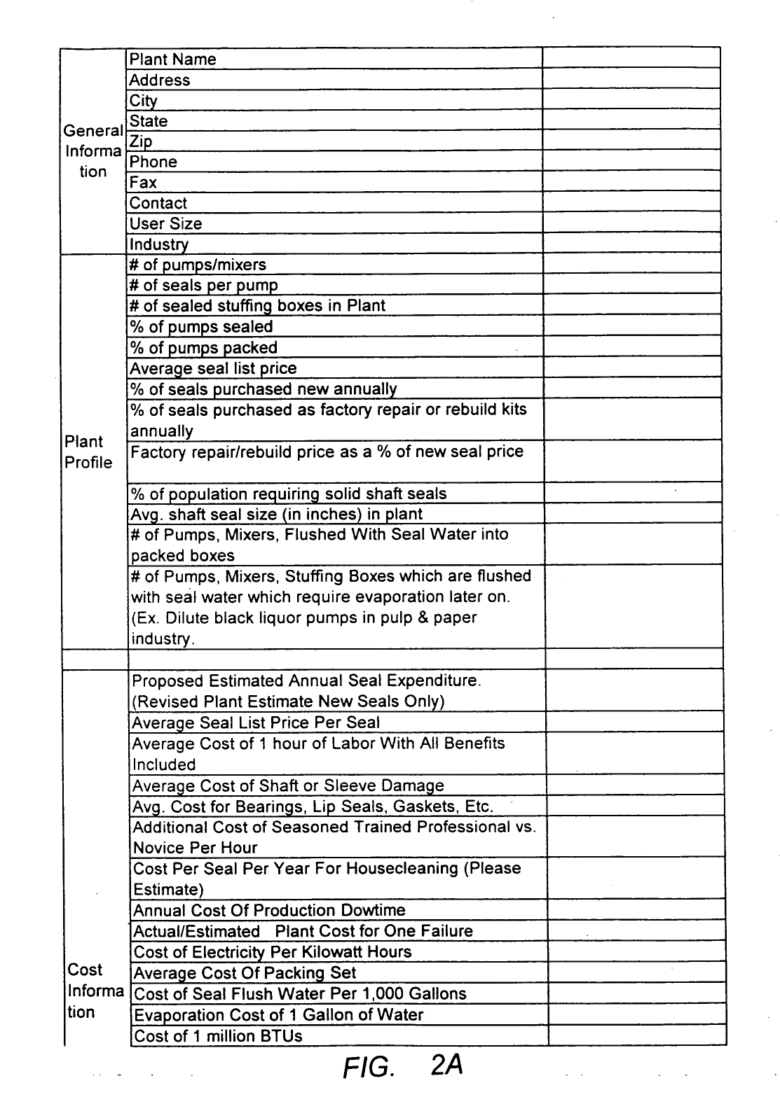

An embodiment of a resource management system will now be described. In FIG. 1, the resource management system 10 uses one or more of several databases. Example contents and structures for these databases will first be described. The several databases that may be used include a user database L, deficiency database M, a resource characteristic database N, an enterprise resource database O, and an enterprise performance database P.

One embodiment of such a resource management system is described in the Plant Reliability application, for resources related to seals and pumps in a plant. The principles described therein may be applied to all resources in an enterprise according to the embodiments described herein. In the Plant Reliability application, the user database L includes a customer database, the deficiency database M includes a problem, failure and leakage database, the resource characteristic database N includes a process fluid database, the enterprise resource database O includes an equipment database, and the enterprise performance database includes a plant performance database.

Using the resource management system 10, an enterprise may better specify a resource to be purchased. A corresponding electronic sales system 12 at a resource provider may be used to take the specifications of the various conditions under which a resource will be used to determine compatibility of the resource with those conditions, and select, manufacture and sell that resource to the enterprise. The electronic sales system and resource management system use a database Q that supports performance of such compatibility analysis, specification of the resource to be purchased, and any custom design and manufacturing that may be needed to produce the resource. Such a system for use with mechanical seals is described in the ESP application.

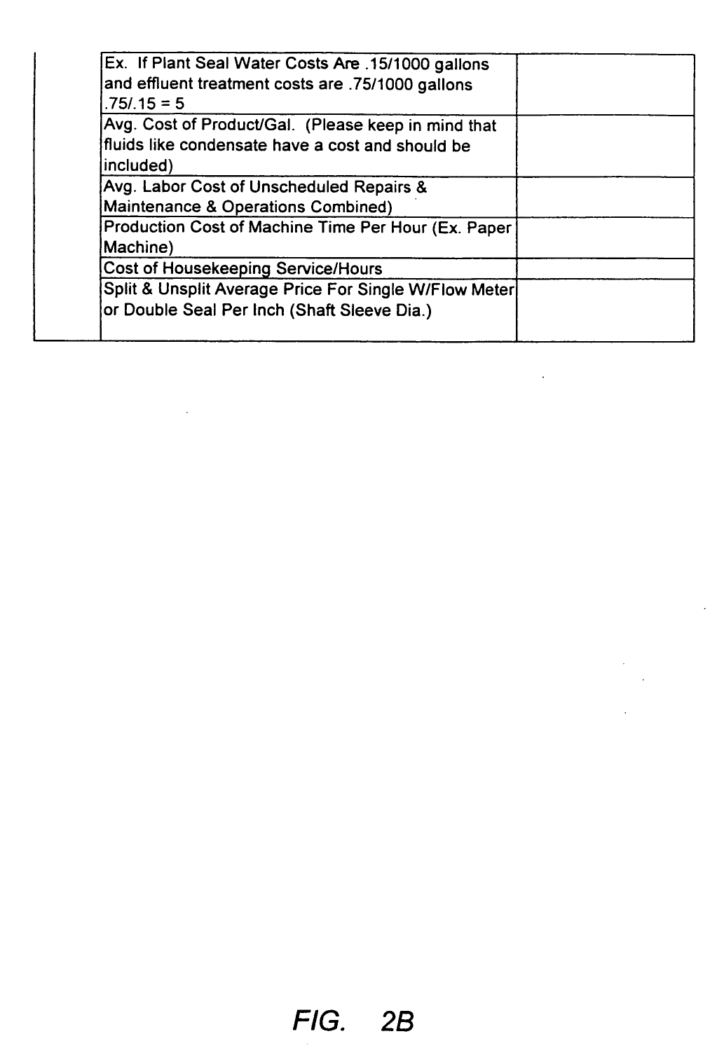

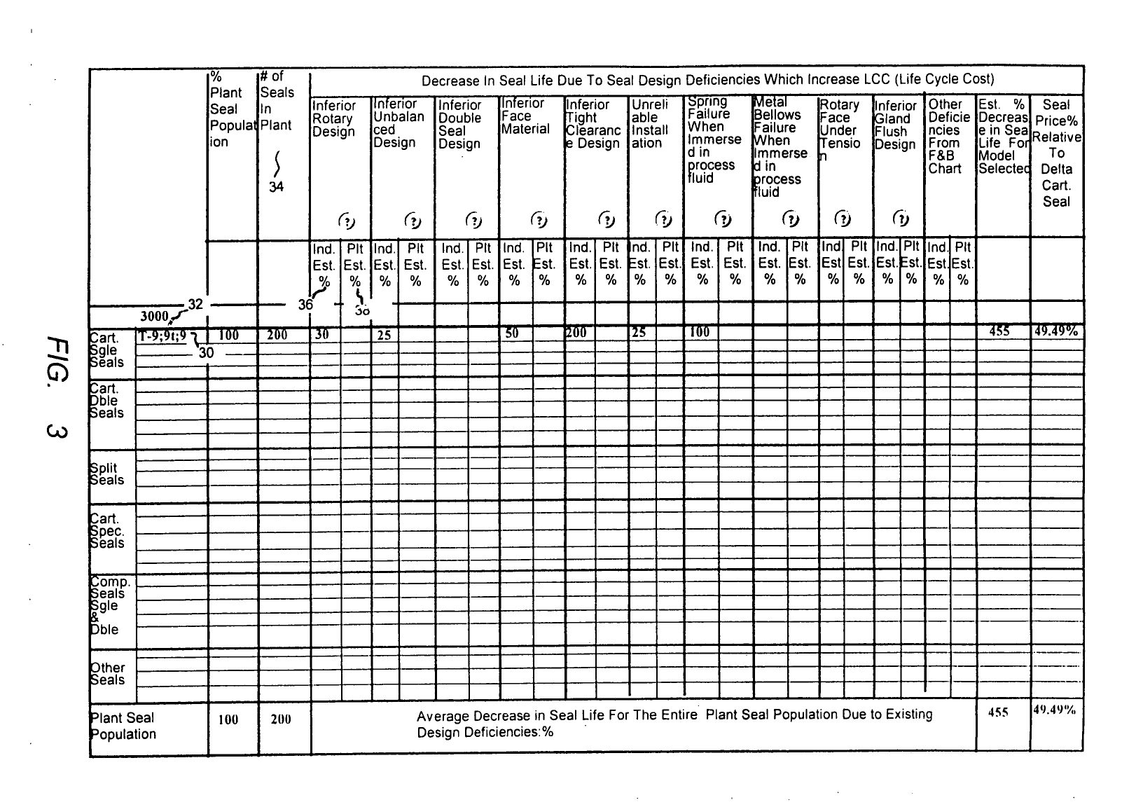

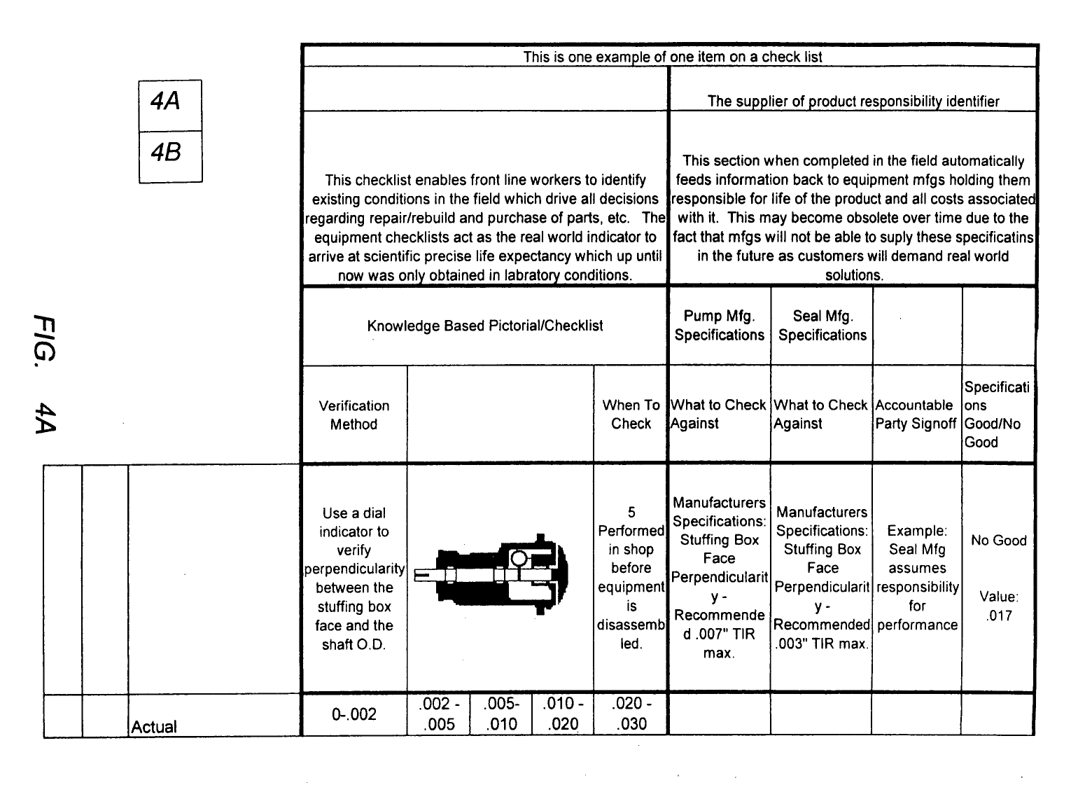

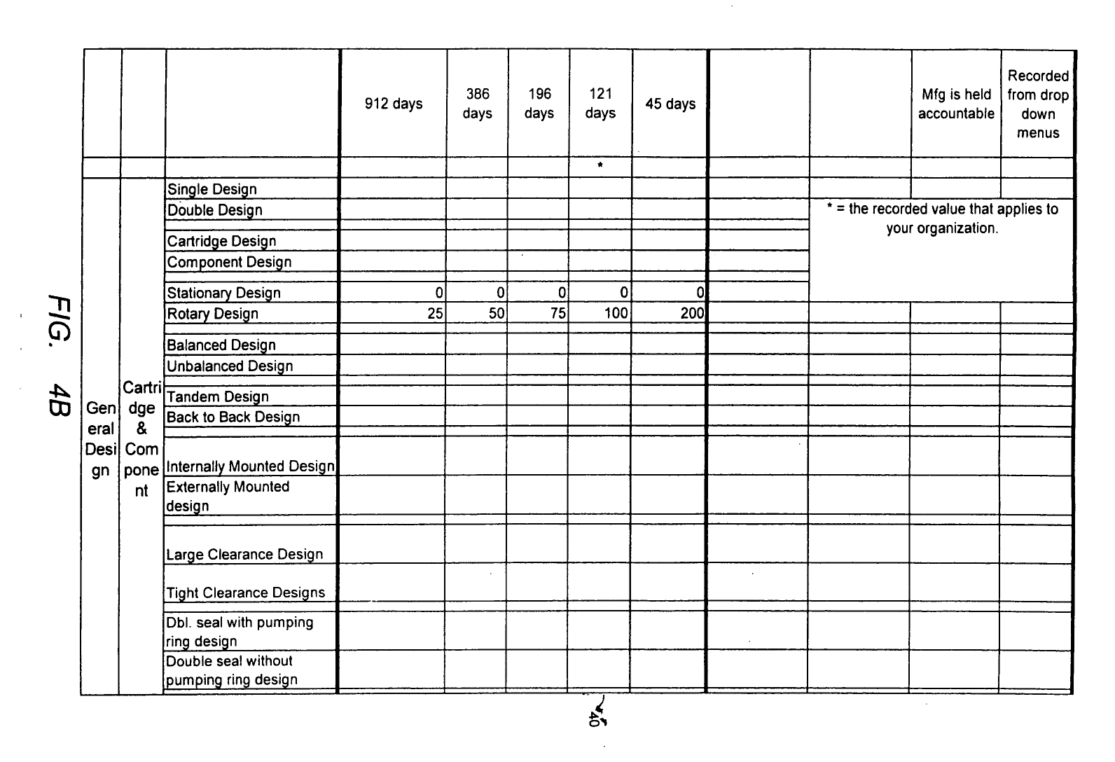

For a general resource management system, the user database L includes general information about the user enterprise, and may include any such information about the enterprise that can be readily obtained, stored and updated. Referring to FIGS. 2A-2B, for example, assuming the user is a plant that purchases and installs and uses mechanical seals, the user database may include general information, such as the name, address, contact and/or other information about the user, a profile of the plant, such as the number of pumps, number of seals per pump, etc. The user database also may include cost information, such as an annual estimated expenditure for various resources, such as seals, and other cost information such as cost of labor, cost of related parts, costs of production downtime, cost of failure, cost of electricity, and other information. Other information may include data about manufacturing processes, goals, motives, objectives, and constraints, such as regulatory, environmental and safety concerns, of the enterprise. This information may be initially populated through checklists, data entry, enterprise resource planning systems, and other sources of the information. Conventional techniques may be used to develop a database structure and an interface for data entry into the database to store this information. Industry information cost centers also may be included.

Deficiency database M is a database of information about predictions, decisions and actions for a resource, and resulting outcomes, along with any related corrective actions. This database may be initially populated using information from those knowledgeable in a particular field. This database includes information about possible problems or failures with a product or service, such as a leakage mode with a seal, and possible causes of the problem or failure, corrective actions, optionally graphics illustrating what the failure should look like or dimensional data defining a characteristic of a failed product, an estimated meantime between failure, an estimated life cycle cost, etc. The information in this database may be comprised of actual measured data or predictions. It should be noted that a prediction, decision or action may be deficient. This database may be continually updated through use of the resource management system as further deficiencies, corrective actions and predicted outcomes are learned for a resource.

Because deficiencies arise in part through the interaction between one resource and another, there are several kinds of interactions that may be represented by the data in the deficiency database. For example, considering mechanical seals, some kinds of interactions include, but are not limited to:

1. impacts of advancements in technology.

2. relationships between required skill levels for a human resource to specify, purchase, install, operate, dispose, or sell a resource and actual skill levels of the available human resources.

3. interactions between operating resources.

4. relationship between an operating resource and a required skill level of a human resource.

5. interactions between an operating resource and a manufacturing resource.

6. relationship between a manufacturing resource and a required skill level of a human resource.

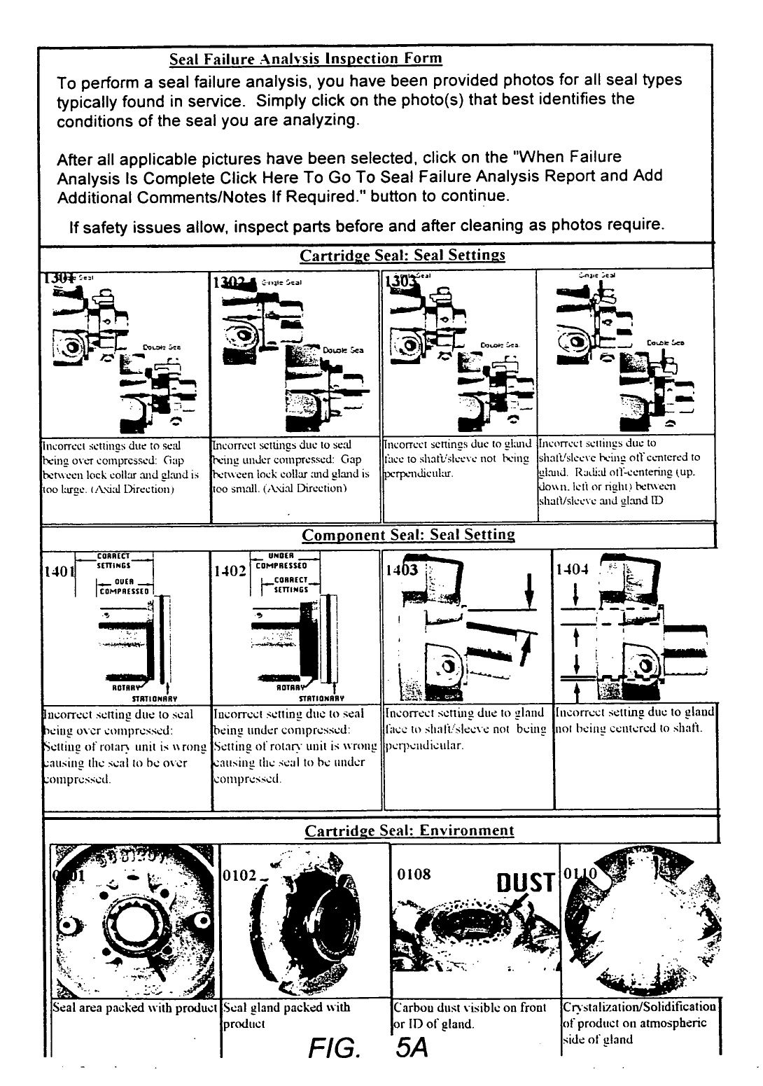

For example, as shown in FIG. 3, the data may represent how advancements in technology impact an estimated decrease in product life for products such as shown at 30 that are not the best-in-class product such as shown at 32. In this example, a listing of several seals, and types of seals may be stored. For each seal, information such as the number of seals in the plant 34, may be stored. Industry and plant average information about characteristics of the items to a known best-in-class item may be provided as indicated at 36 and 38. For example, if a seal is known to experience spring failure when immersed in the process fluid as indicated at 37, this information may be stored. Information about each of the known deficiencies or failure modes of a product may be stored.

Referring to FIG. 4, an example of the impact of an operating resource, such as a mechanical seal with another operating resource, such as other equipment, will now be described. For example, various design information about a seal may be mapped to measured pump characteristics. The measured pump characteristics combined with the information about the seal may provide information about the projected lifetime of the equipment. The database provides a knowledge based pictorial checklist for the information to be provided by a worker that inspects the equipment. For example, a worker might measure a stuffing-box-to-shaft perpendicularity of 0.015 on a cartridge or component seal with a rotary design, which may be related to a lifetime of 121 days as indicated at 40. The information may be presented to the user in the form of a drop down menu or checklist. By selecting the value measured, the system records that value and displays the corresponding expected life.

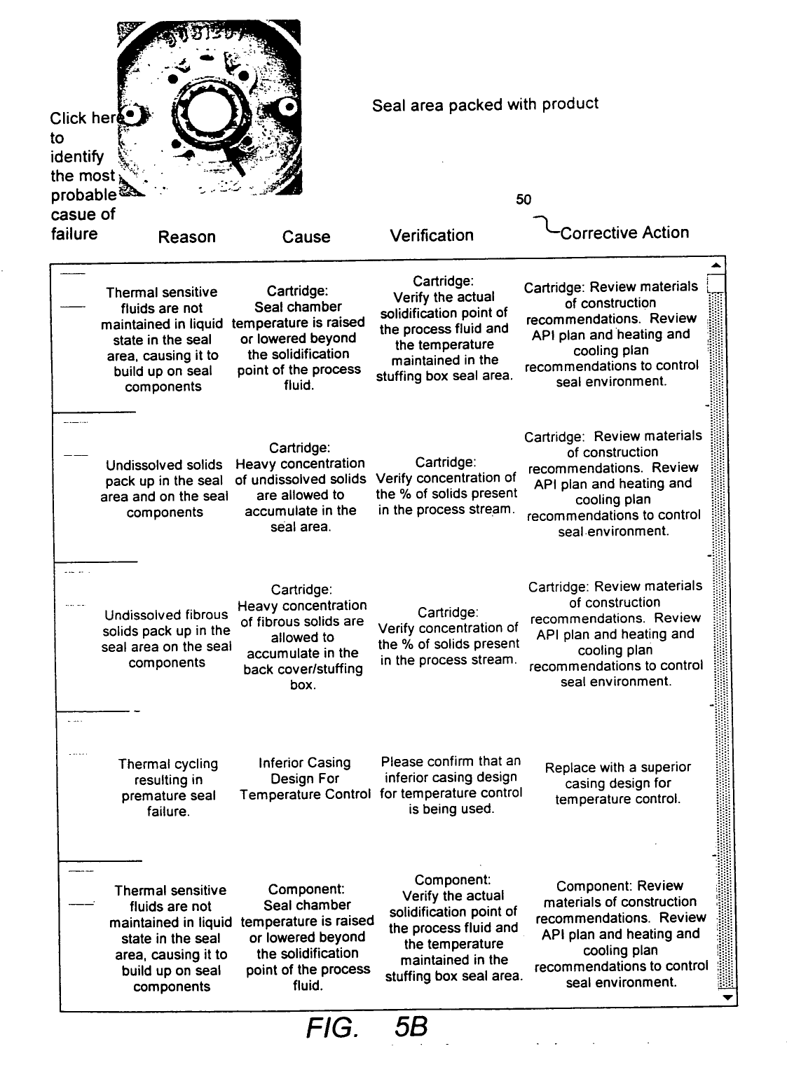

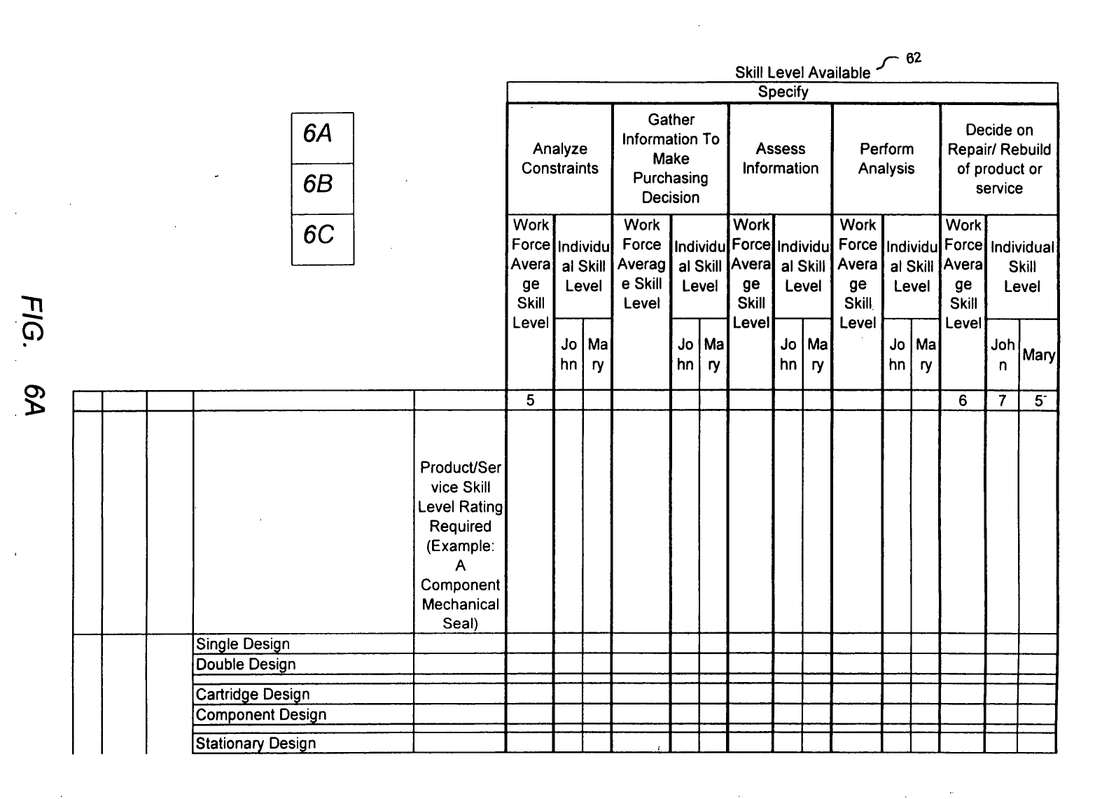

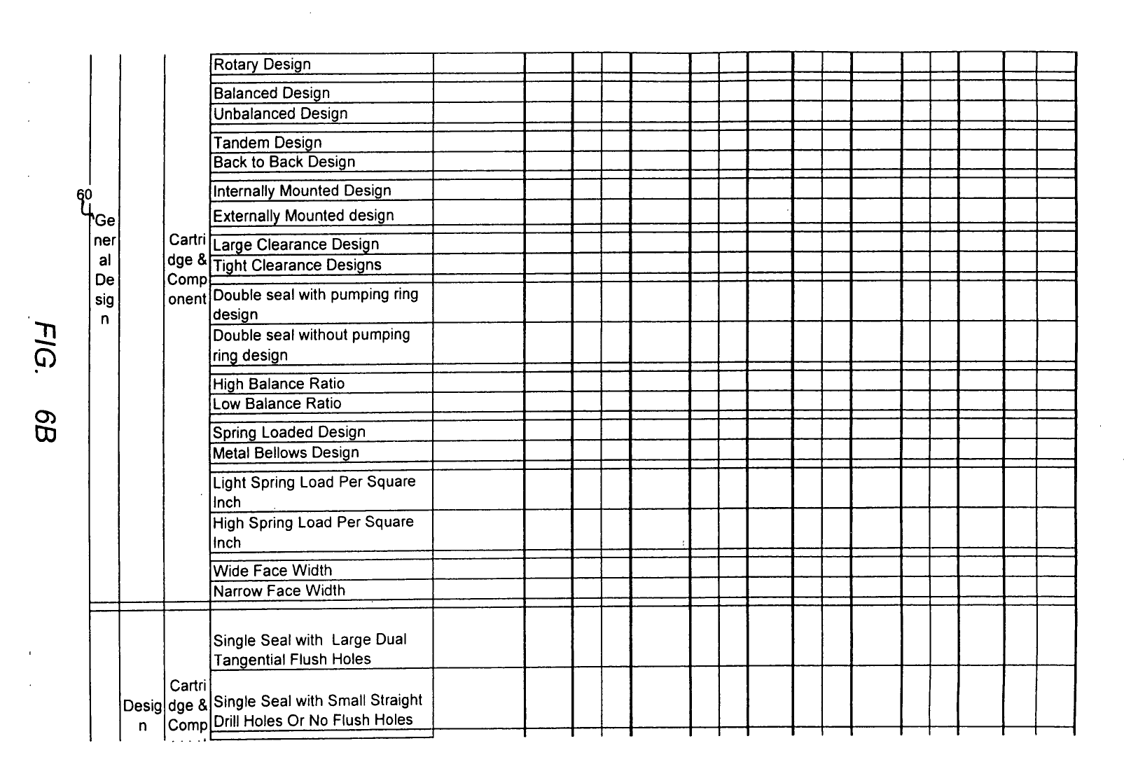

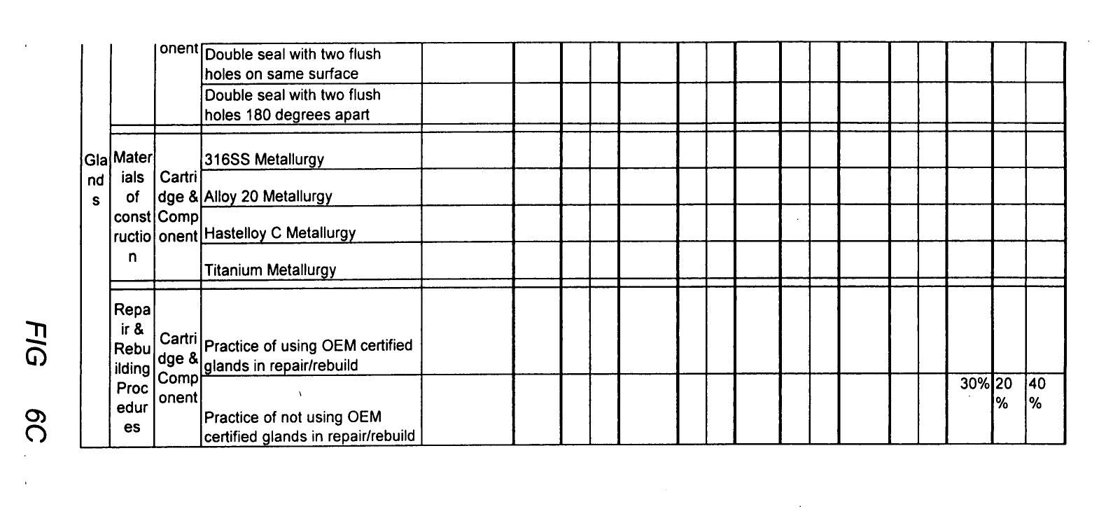

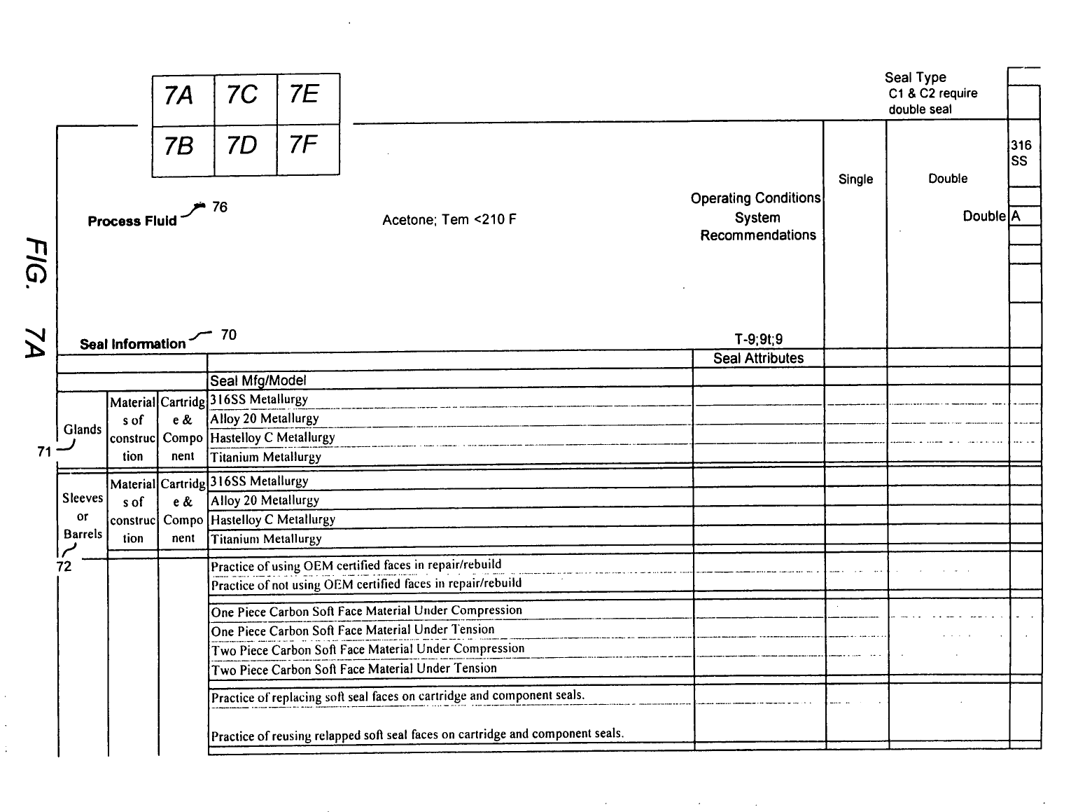

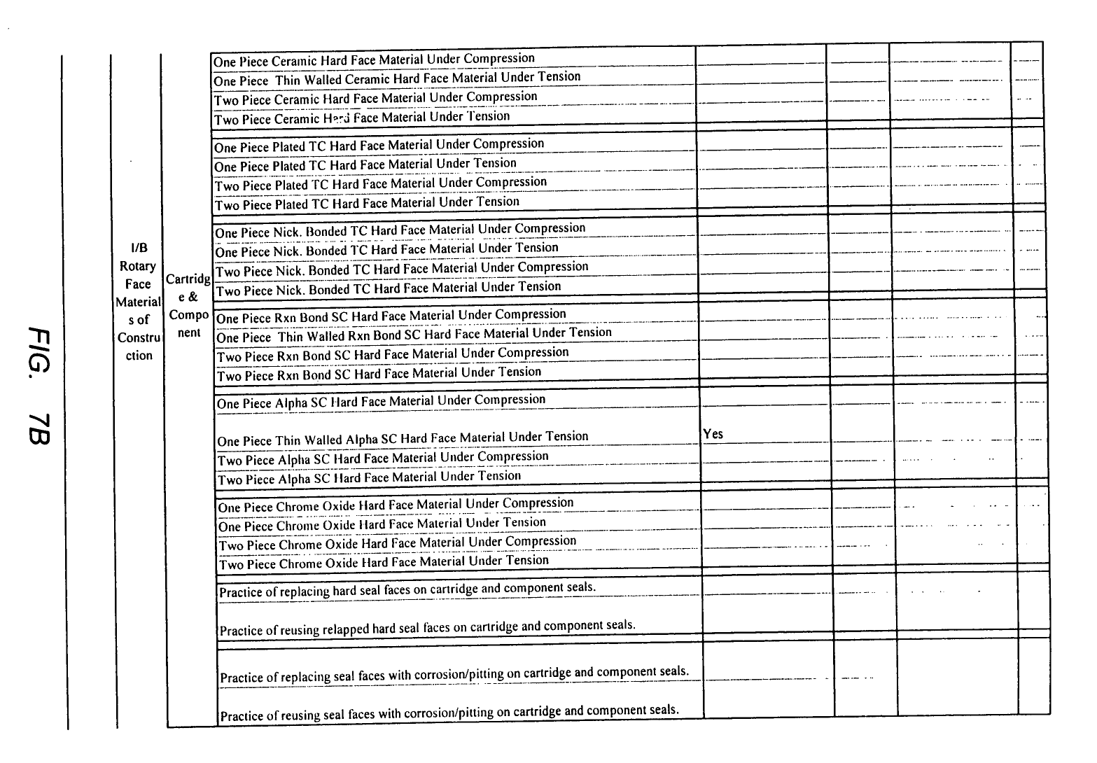

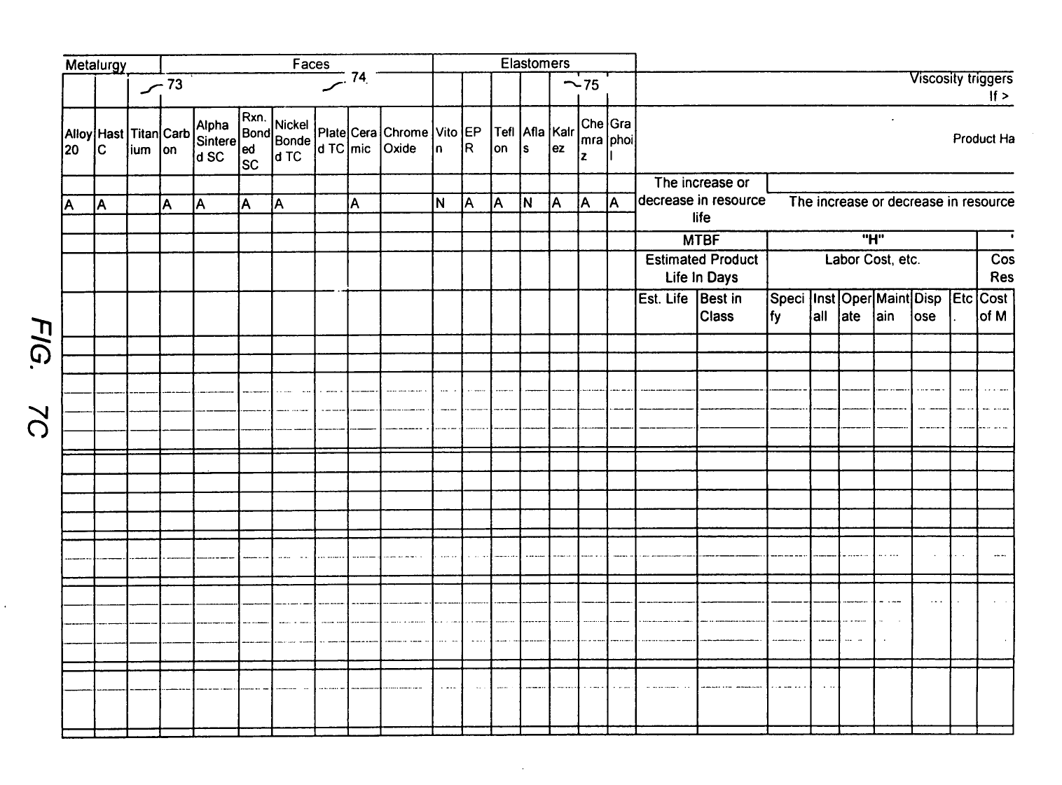

Graphical information also may be stored in the database for a resource, for example to store pictorials and checklists to enable detection of defects in both decisions and workmanship with respect to resources. For example, as shown in FIGS. 5A and 5B, graphical information of seal settings in incorrect installation may be stored, or graphical information of environmental conditions of failure modes may be shown. The graphical information as shown in FIG. 5A enables a user with any skill level to indicate what the failure mode looks like, accurately and consistently. A checklist as shown in FIG. 5B enables a user to objectively select what they see, hear, touch, smell or measure to identify the most probable cause of failure. By using the graphics and allowing selection in a checklist of the most probable cause of failure, verification may be formed by matching the known causes for the failure modes associated with the selected graphic and the known causes for the selected reasons. Various corrective actions may be stored, such as shown at 50, indicating how to correct the deficiency.

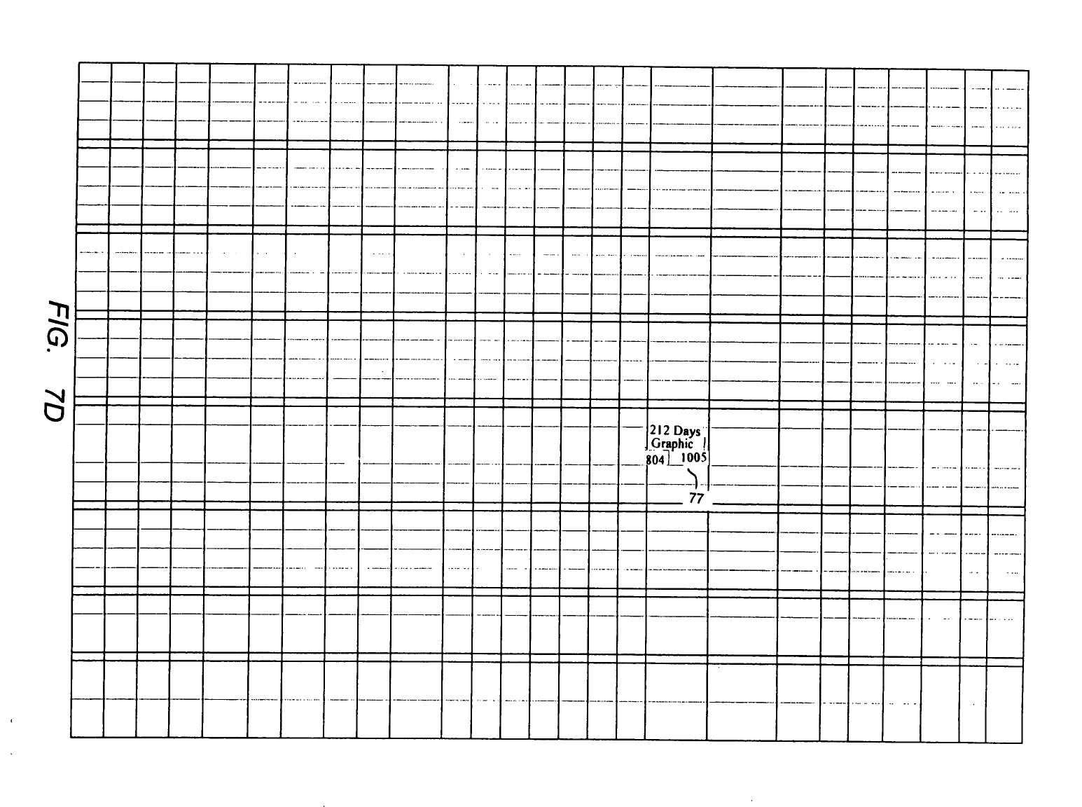

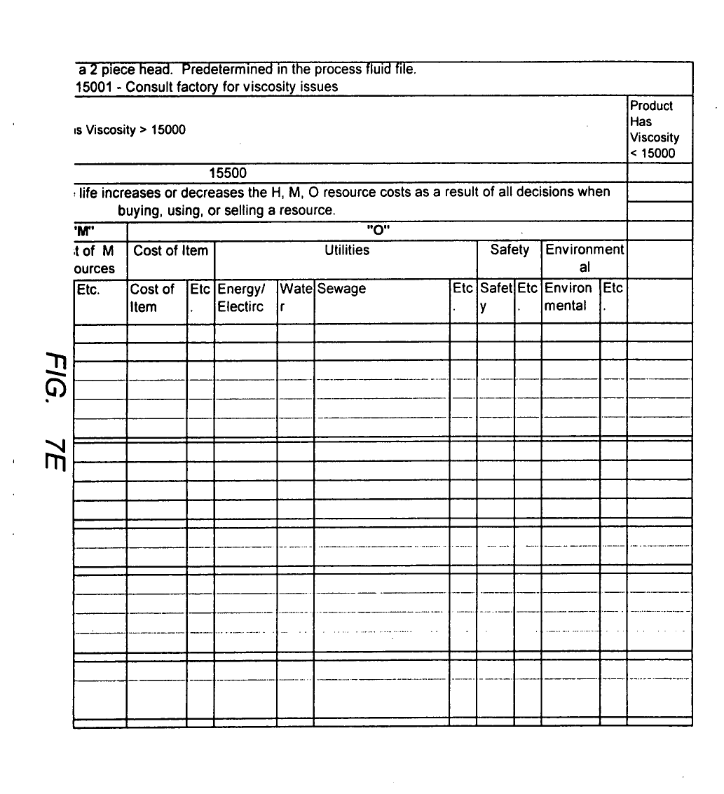

Example information for the deficiency database M that illustrates relationships between an operating resource, such as a mechanical seal, with characteristics of a human resource, such as skill level requirements, is shown in FIG. 6. In this example, information about the general design of different seals as shown at 60 is mapped to predictions, decisions or actions to the skill level 62 of individuals that perform those activities.

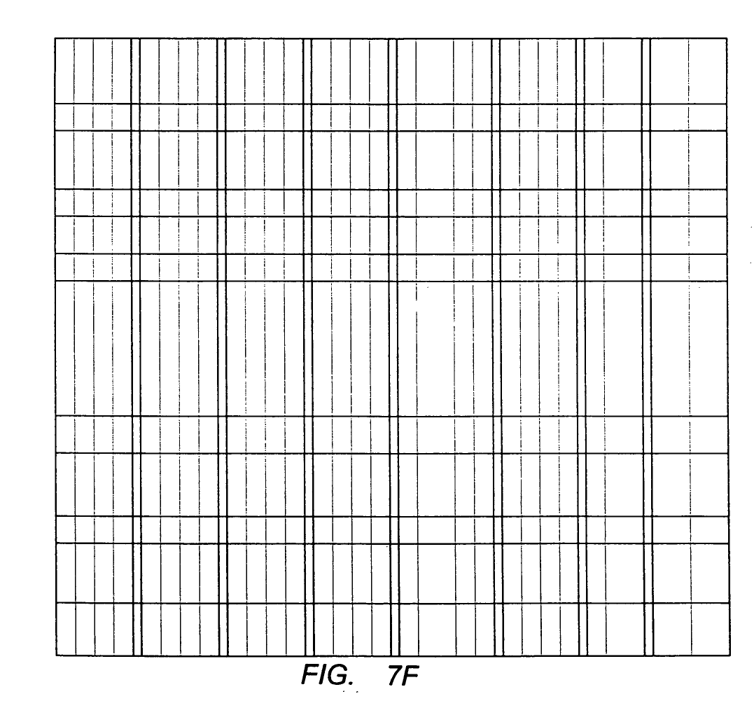

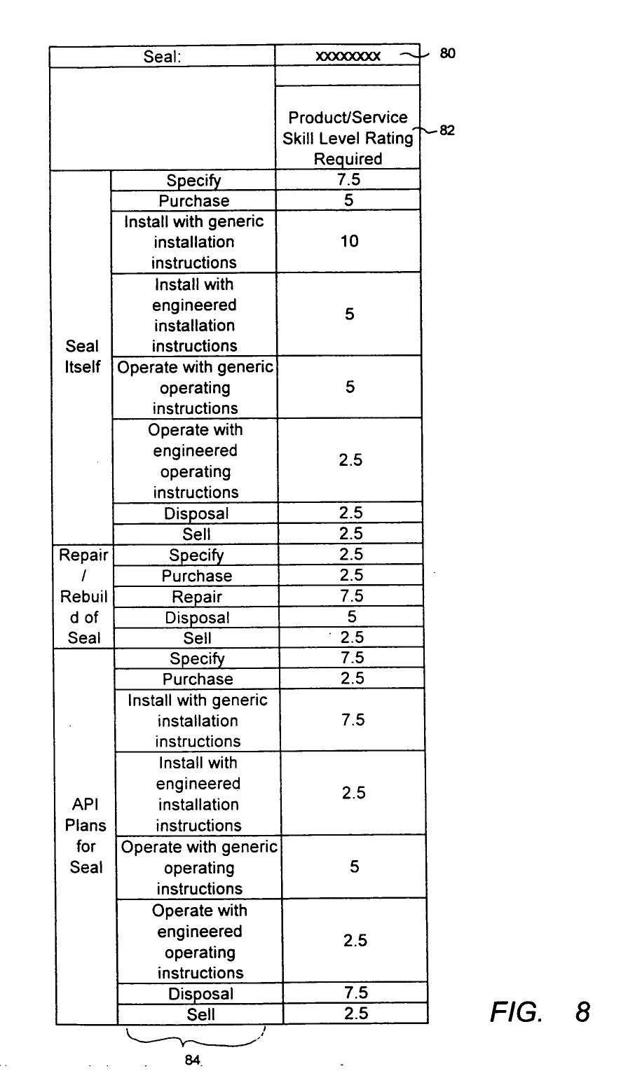

Example information for the deficiency database M that illustrates relationships between an operating resource, such as a mechanical seal, with manufacturing resources, such as materials of construction and process fluids, is shown in FIGS. 7A-7F. In this example, information about the seal 70, such as the materials of construction of glands 71, and sleeves or barrels 72, with the characteristics of the seal, including its metallurgy 73, faces 74 and elastomers 75, are compared for a given process fluid 76. Each combination of characteristics of the two resources may be associated with an impact on the estimated life in comparison to the best in class product. For example, as shown at 77, the example shows a value of 212 days, indicating that this combination of characteristics results in an estimated life that is 212 days less than the best in class. A corrective action for this deficient combination would be identified by the entry in which the estimated decrease in life is zero.

In the foregoing examples, each cell in the matrix of characteristics mapping one resource to another resource can be associated with an impact on the expected lifetime of the resource or an expected failure mode of the resource. Such information may be gathered from those knowledgeable in the field, or may be gathered over time automatically through use of the system.

Resource characteristic database N stores characteristics and attributes of resources. This database includes any information about any human, operating and manufacturing resources, and their interactions. This database may be initially populated through submission of information from those knowledgeable in the field and may be updated over time as the system is used. For example, for resources related to seals, as shown in the ESP application, process fluid recommendations and compatibility ratings for all materials of construction, piping plan recommendations, etc., may be stored in this database.

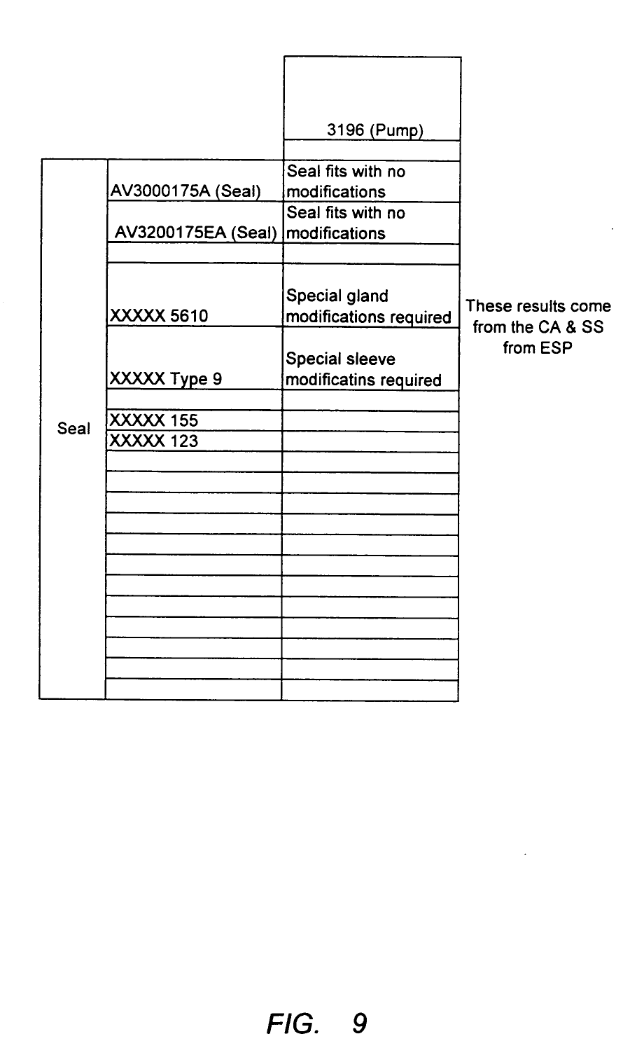

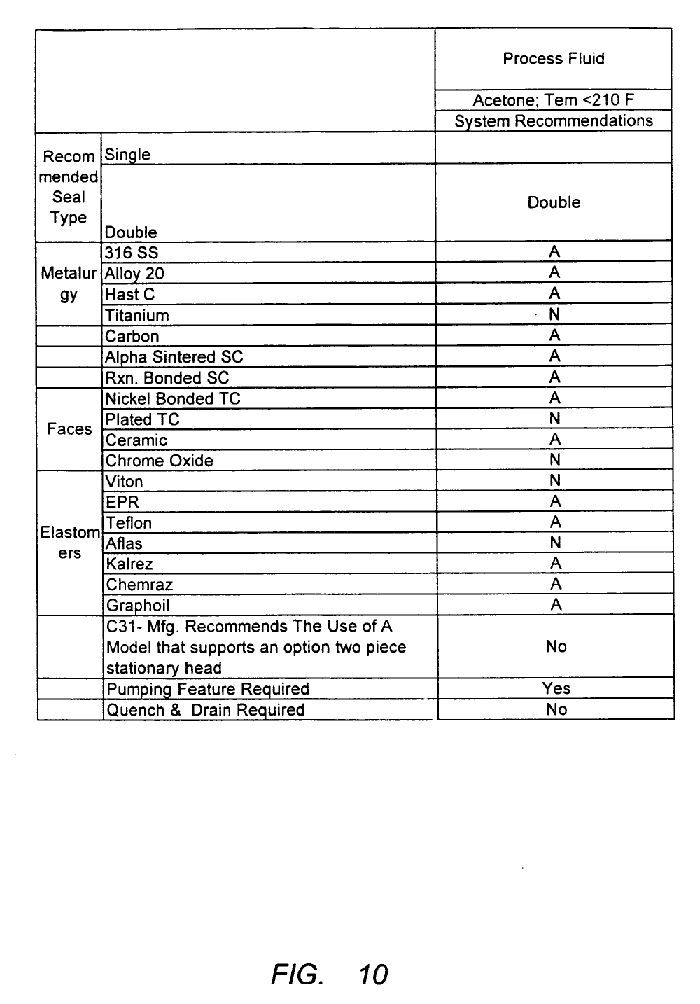

An example of information that may be stored in the resource characteristic database N includes, for example, data matching a resource to a skill level rating for performing various actions in connection with the resource. As shown in FIG. 8, a seal 80 may be matched to a service skill level rating 82 required to perform various actions 84 in connection with the seal. Similarly, requirements of a pump for a seal may be stored, as shown in FIG. 9. Similarly, requirements of a seal (e.g., materials of construction) for using a process fluid may be stored, as shown in FIG. 10.

The enterprise resource database O includes the characteristics and attributes of all H, M and O resources that actually exist in an enterprise. This information may be obtained by checklists, data entry, data acquisition from an enterprise resource planning system, electronic inputs, e.g., from pressure, temperature, vibration transducers, etc., and electronic condition based monitoring devices. This database includes all pertinent information on every piece of equipment for example, or other resources, including human resources. For example, this information may include, for a pump, a pump identifier, the process fluid being pumped, the seal installed, piping configurations, motor information, bearings, couplings, etc. For manufacturing facilities, data for any maintenance, repair and operation equipment may be captured. Information over time about the equipment condition, LCC cost, failures and deficiencies may be tracked in this database as well. For example, for human resources, the skill and knowledge level of each employee may be stored over time.

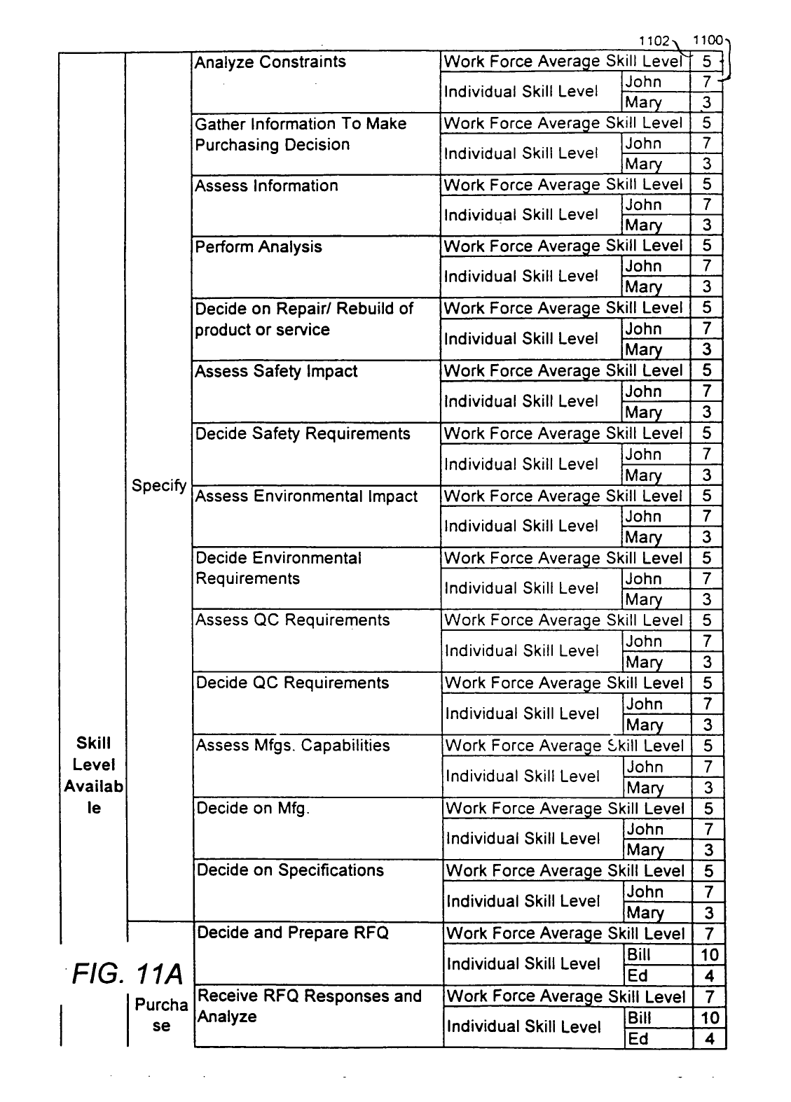

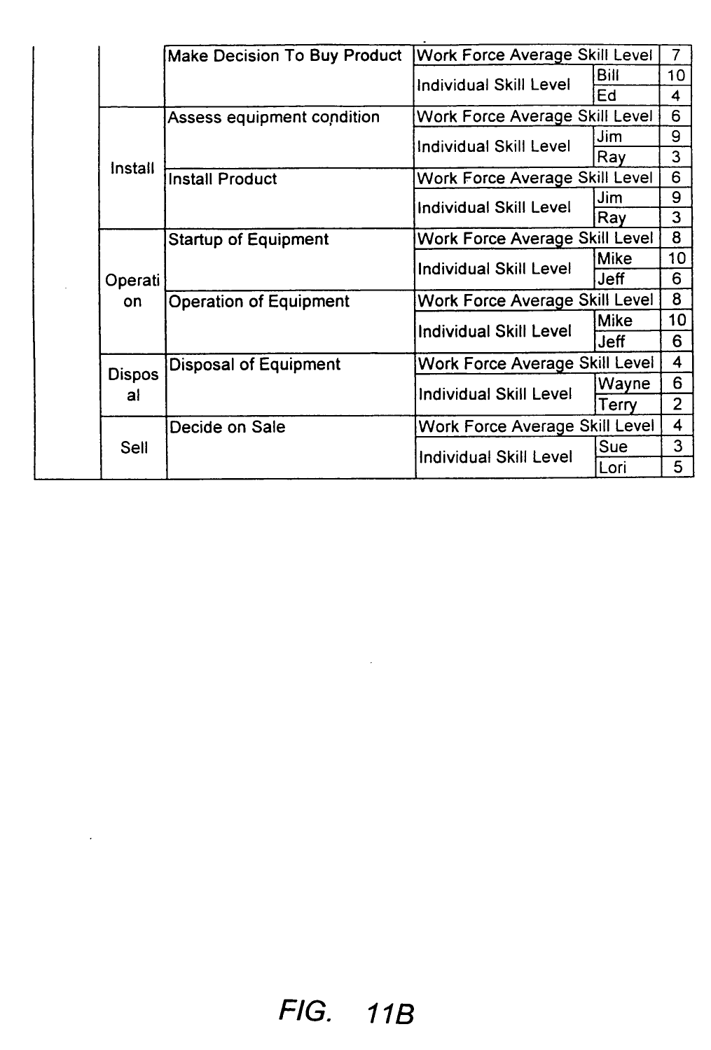

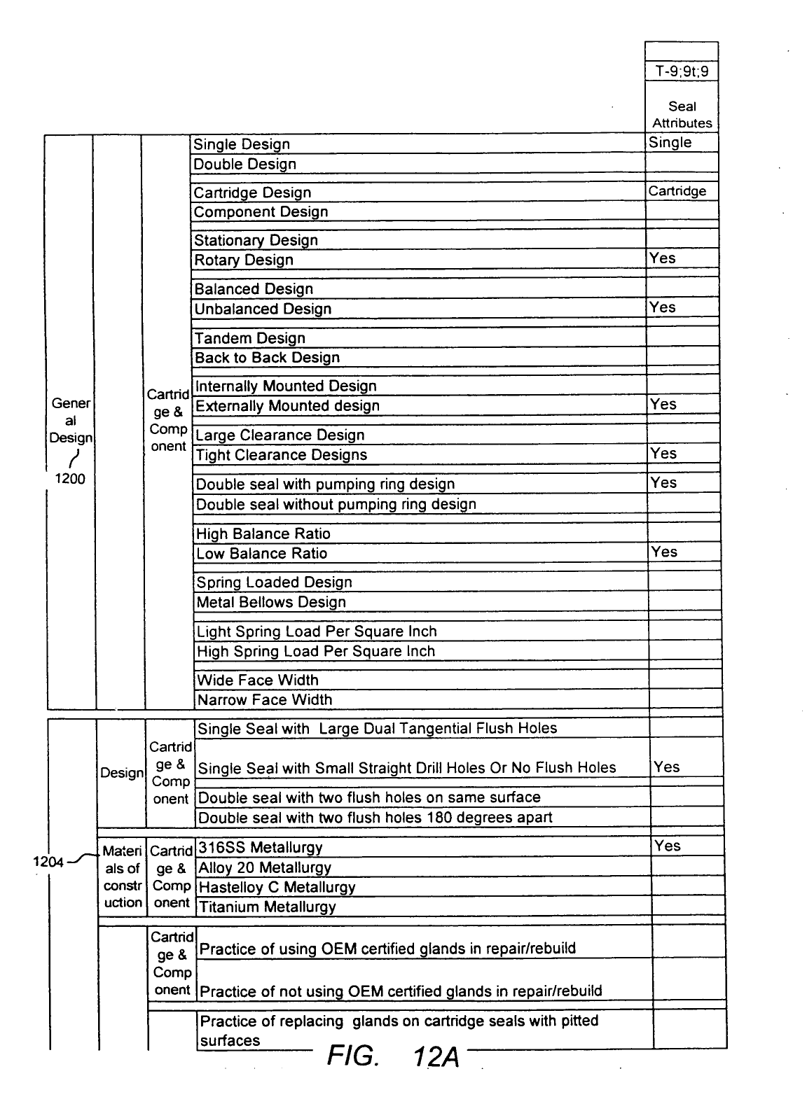

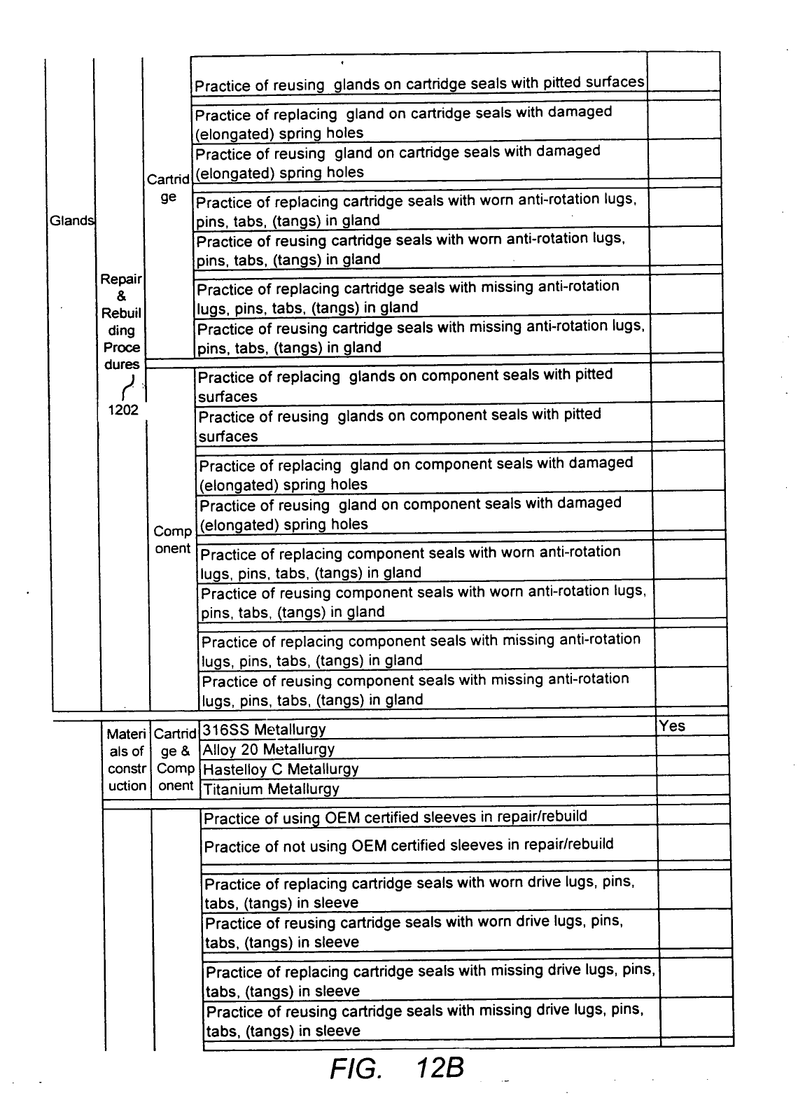

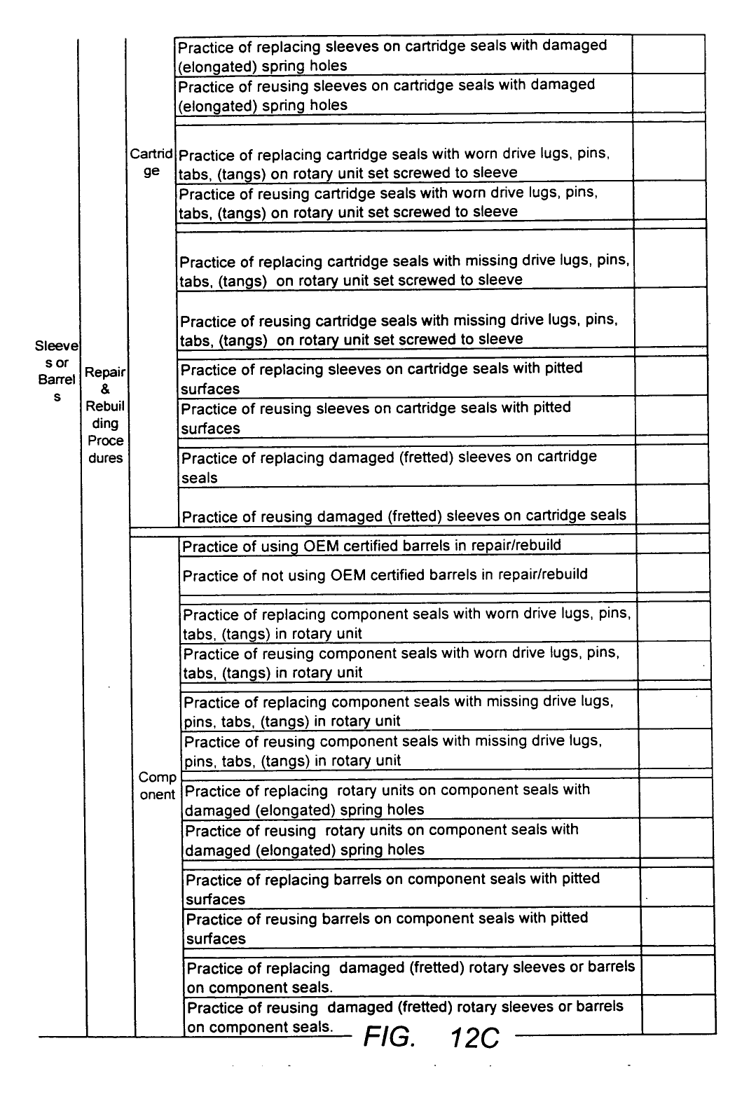

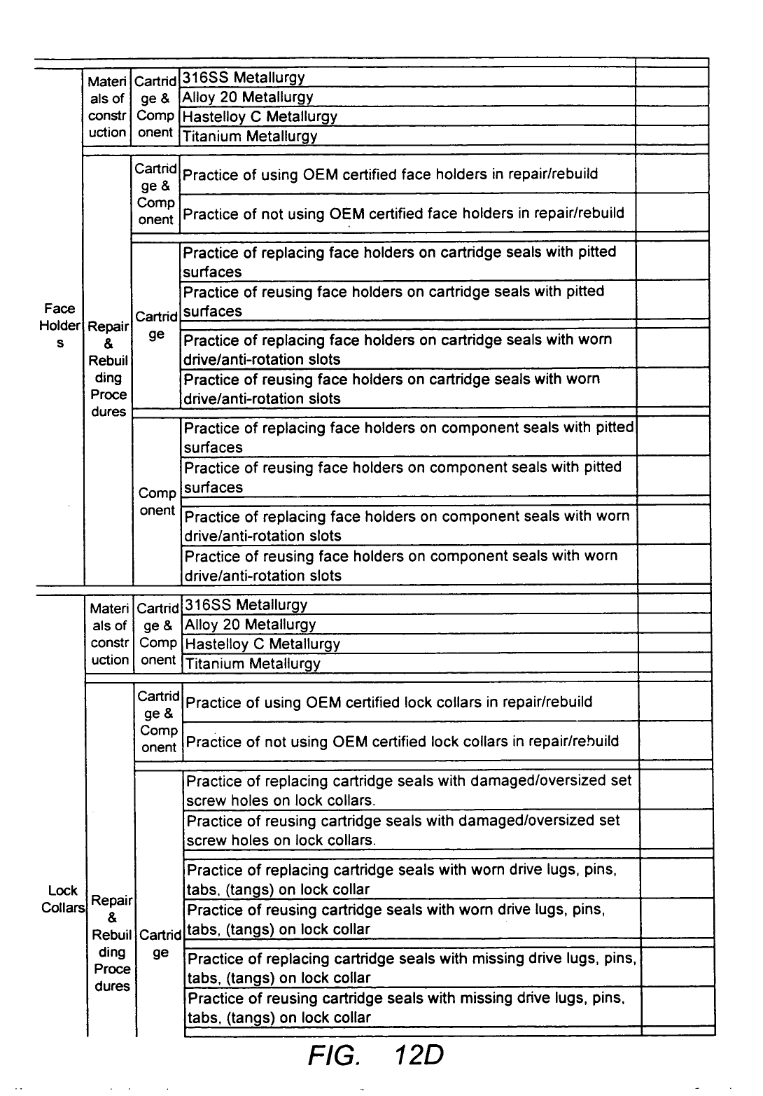

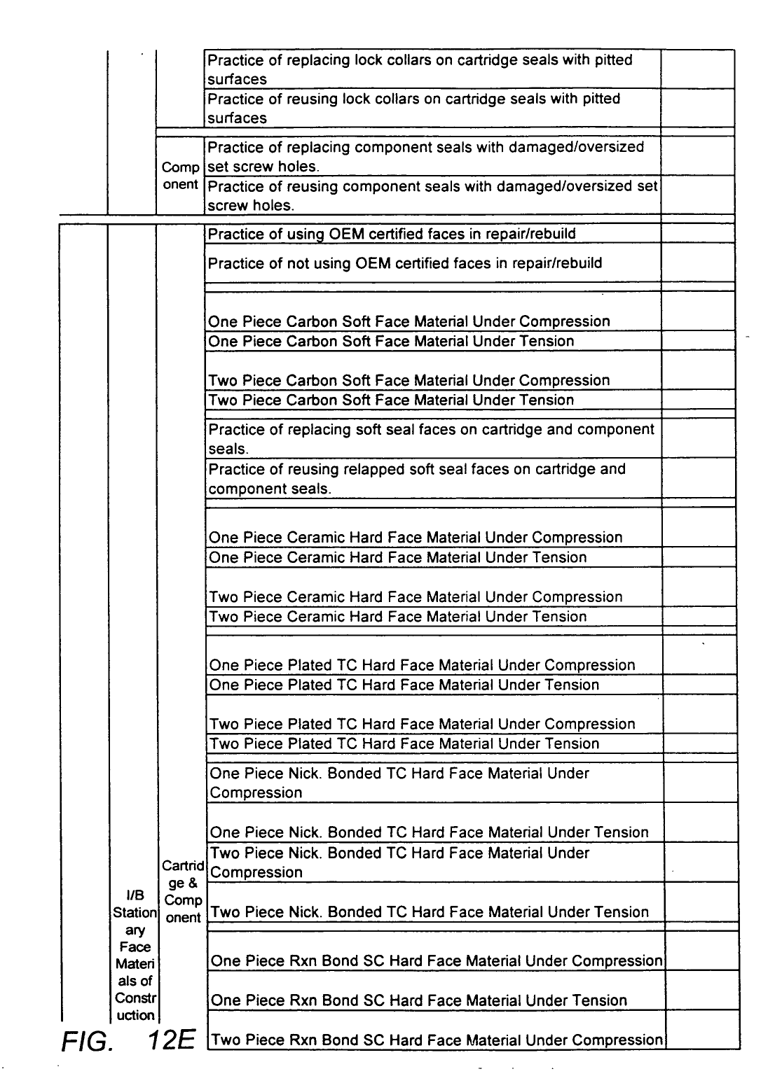

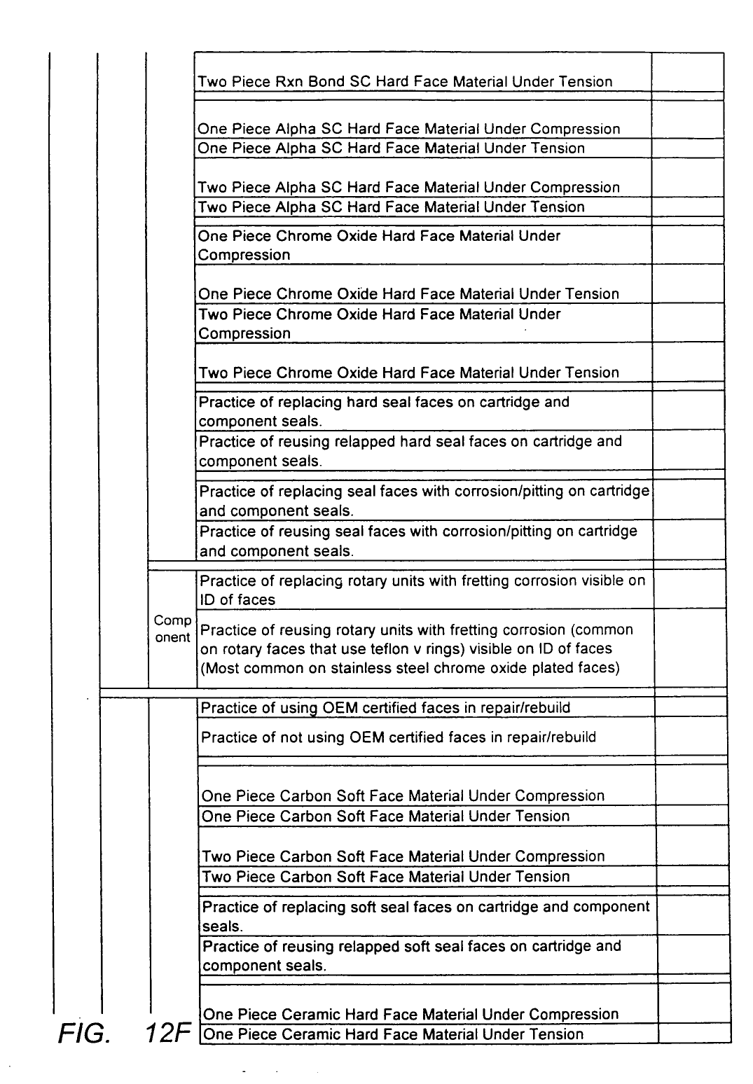

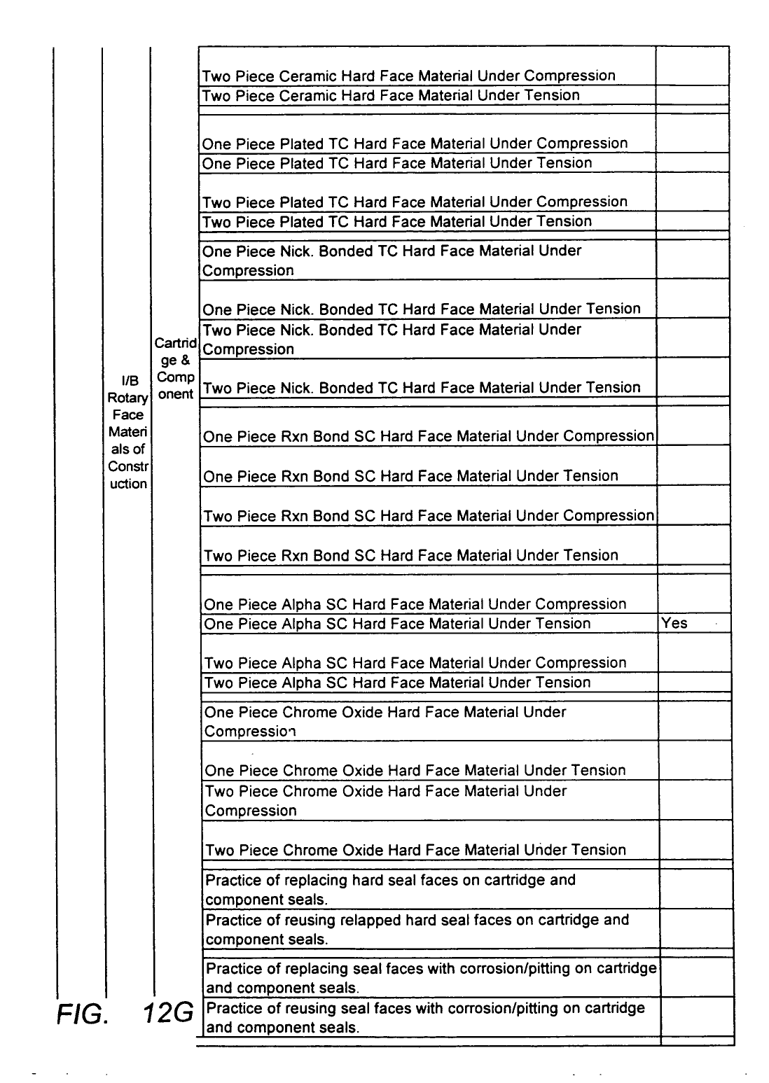

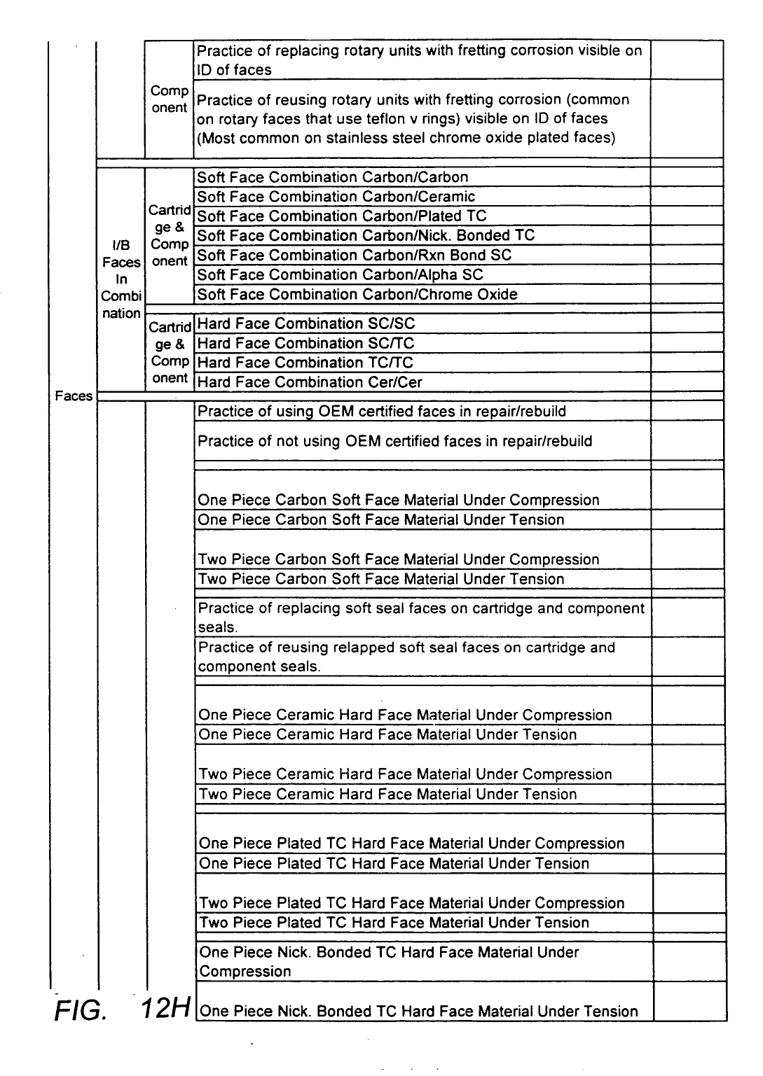

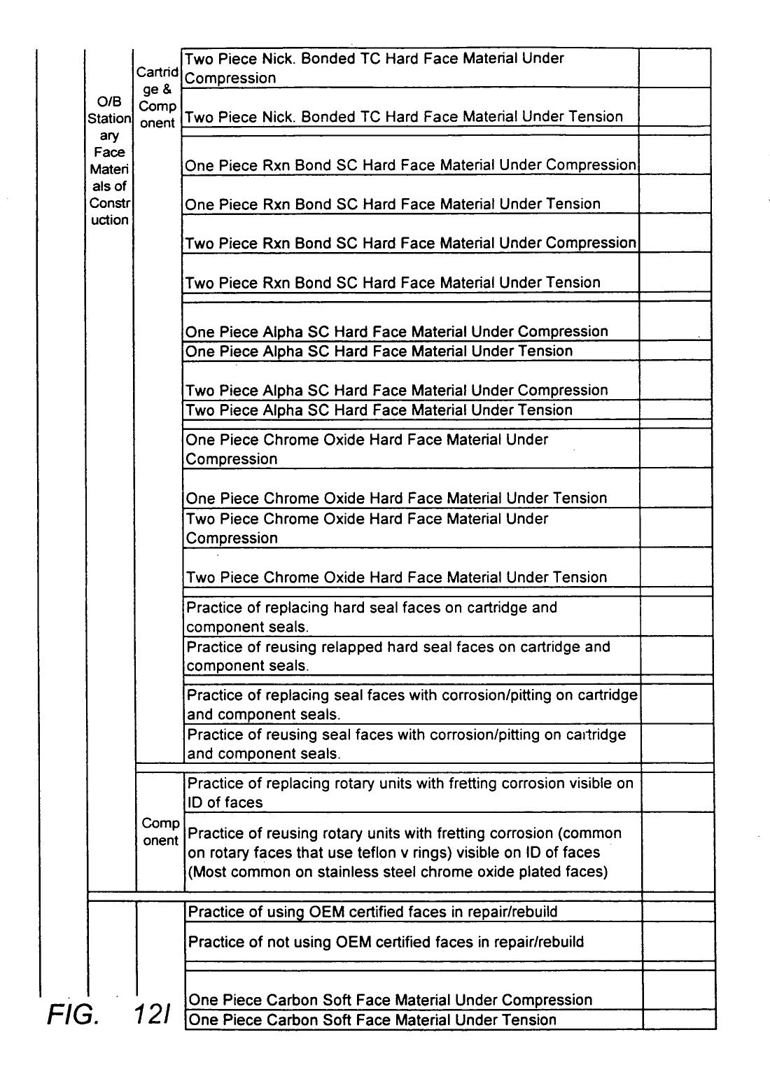

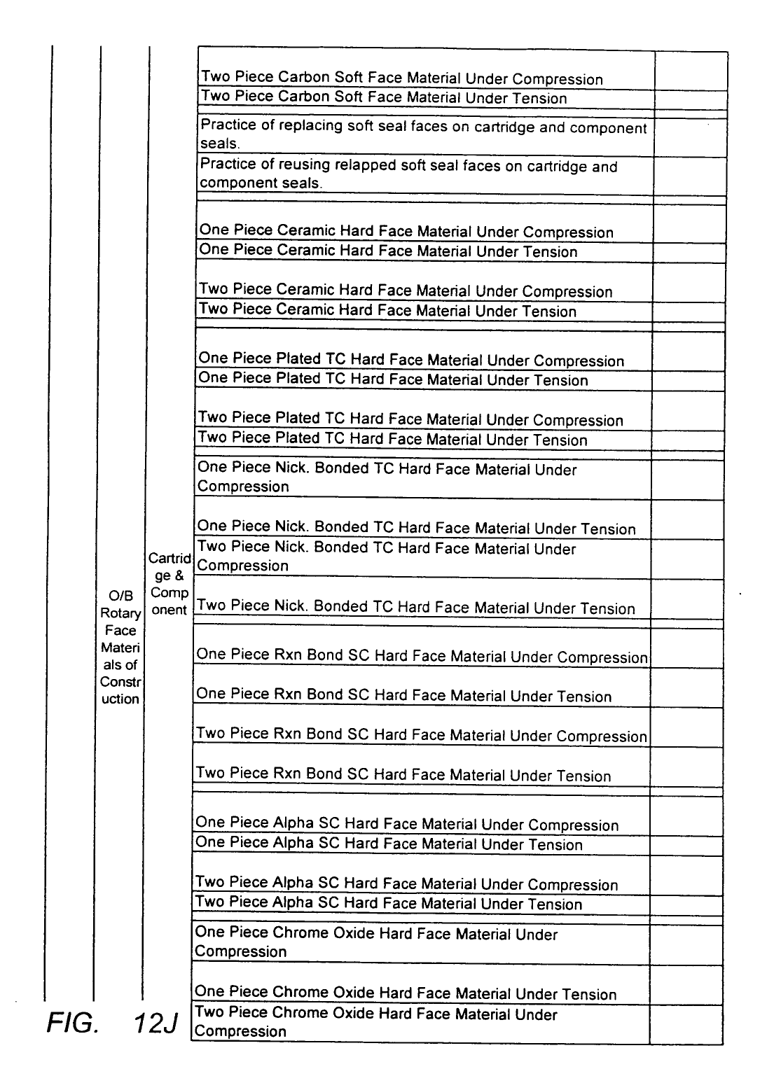

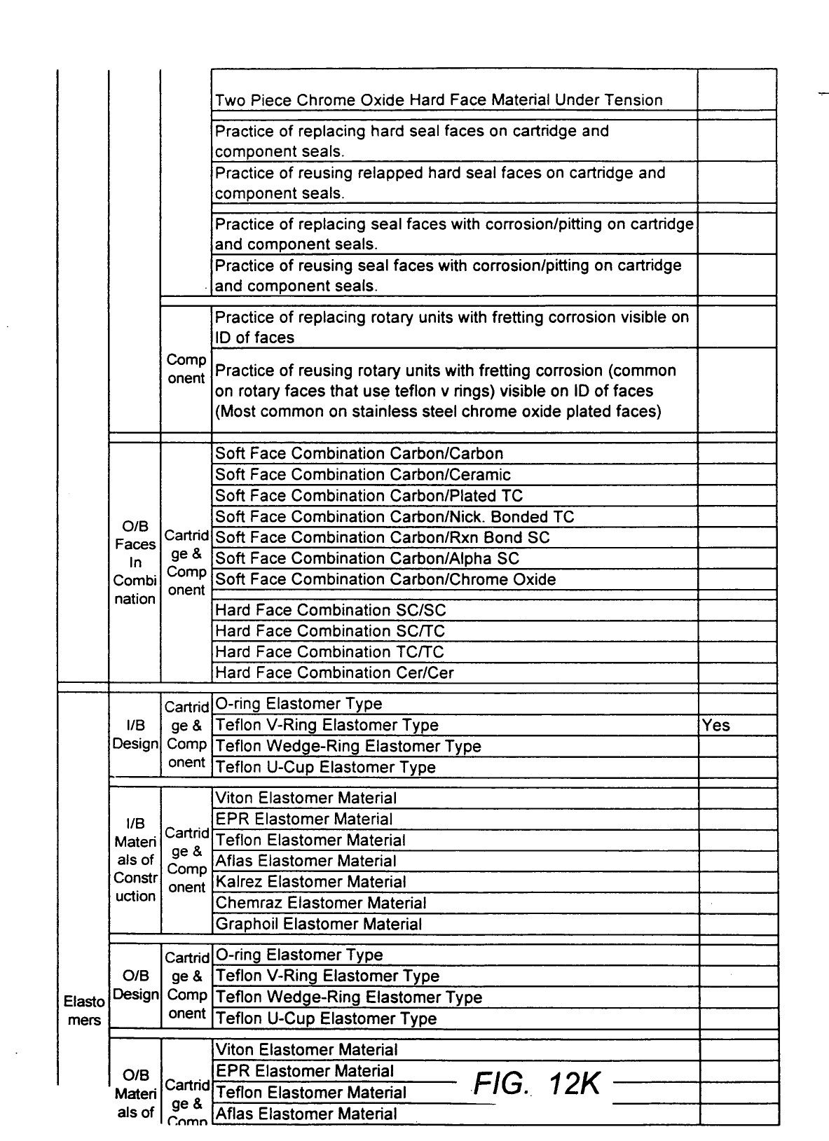

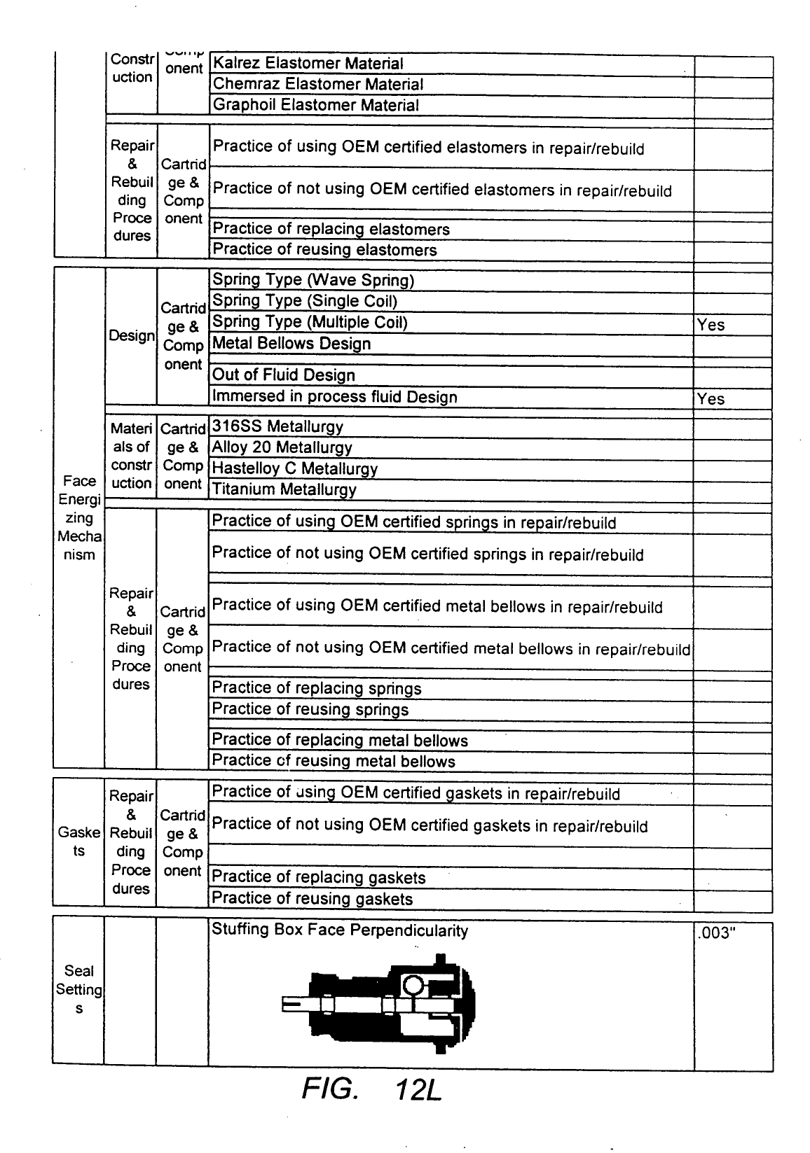

For example, as shown in FIGS. 11A-11B, for a human resource, a skill level of an employee for performing different tasks may be tracked as indicated at 1100, and the workforce average skill level 1102 may be tracked. As shown in FIGS. 12A-12L, information for operating resources, such as each resource seal, may include various specifications of the resource. For a seal, such information may include general design information 1200, repair and rebuilding procedures 1202, materials of a construction 1204, and other information about the seal. An example for a manufacturing resource is shown in FIG. 13. In this example various system recommendations 1304 for using a specific process fluid 1302 are stored. An example enterprise resource database may include, for example, an equipment database such as described in the ESP application.

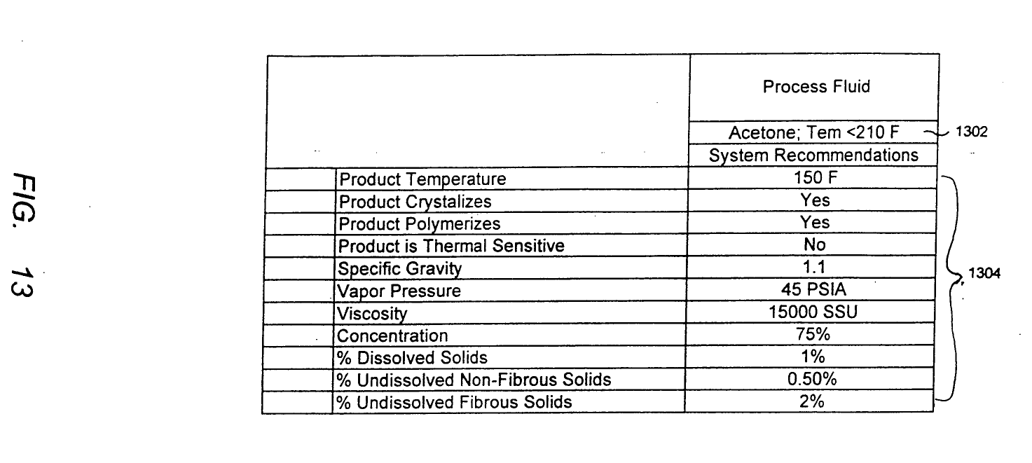

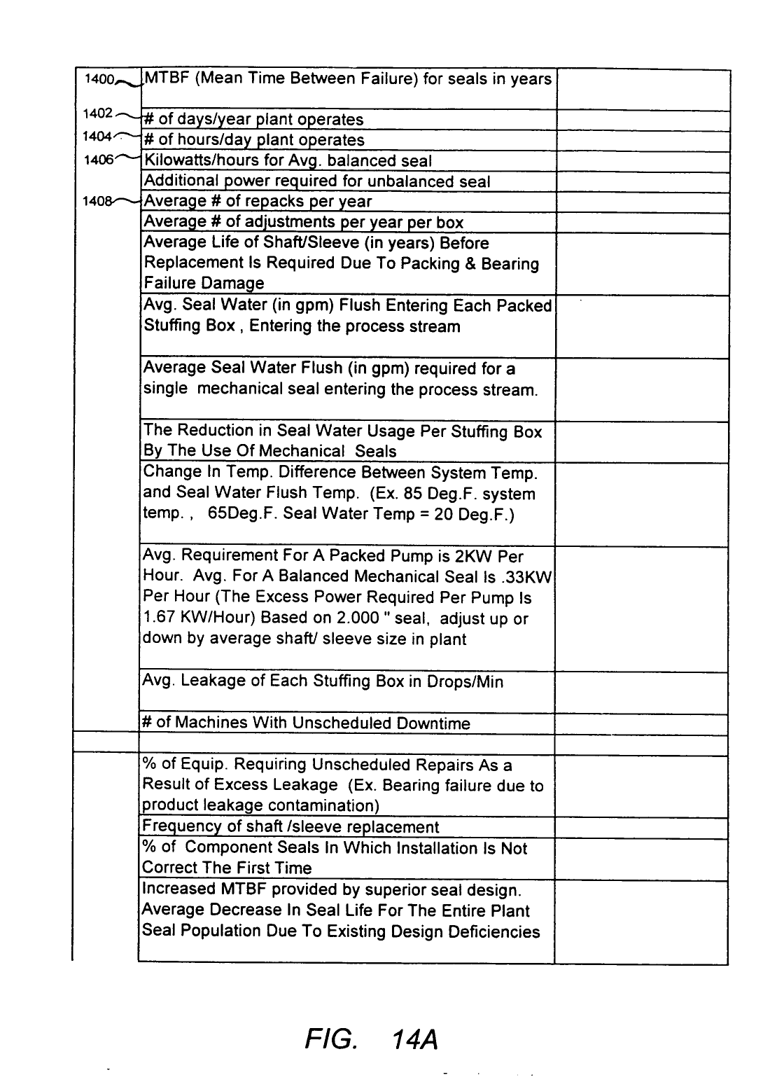

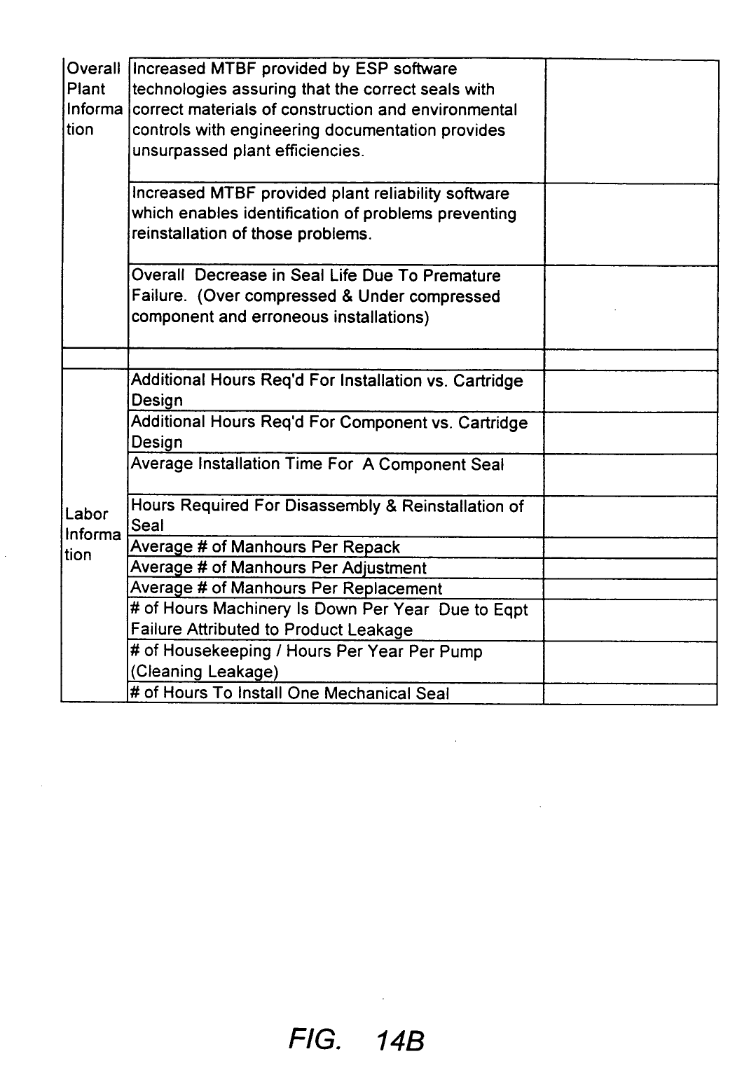

An enterprise performance database P stores various information about an enterprise, such as purchasing information, identities of outside contractors, vendors, equipment, process stream changes, accuracy of information, analysis of lifetime cost, meantime between failure, equipment downtime, etc. This database may be initially populated through check lists, data entry, accessing an enterprise resource planning system, and other sources of this information. An example of information that may be included in the plant performance database, for example with respect to mechanical seals and pumps, is shown in FIGS. 14A-B. Such data may include the mean time between failure for seals in years 1400, the number of days per year 1402, and hours per day 1404 that a plant operates, repair information 1408, electricity usage 1406, etc. Information may be retained as average values or as granular metrics. An example enterprise performance database may include, for example, a plant performance database as described in the ESP application.

Having now described various databases for the resource management system, various components, and their operation, of the resource management system will now be described in connection with FIGS. 15, 16A-16F and 17. These flowcharts illustrate activities involved for analyzing, buying, using, operating and selling human, operating and manufacturing resources. In general, the databases described above provide the information about the resources, their deficiencies, associated corrective actions, costs, suppliers, pricing, etc. Because the database stores this information with respect to a best in class or other solution, improved solutions are readily identified through the database. The following flowcharts describe how the information in the databases is linked together to allow a user to arrive at a solution given the specification of resources and goals and constraints in the enterprise.

Corporate, management, or individual goals and objectives are defined as indicated at 3000. In general, a user may enter in goals and objectives to simulate situations as indicated at 3002 or a user may define actual goals and objectives, or this information may be gathered from previously stored goals and objectives as indicated at 3004. Any entered information is stored in user database L as indicated at 3006. A typical goal may be lowest cost, lowest cost for a specified period of time, safety, environmental concerns, or best in class solution. The impact of resources on each other may be defined in terms of their impact on the ability to achieve the stated goal. It is assumed in most of the examples herein that the goal is to provide the lowest lifetime cost for each resource, depending on a specified time frame. For example, there may be a difference in a buying decision for a mechanical seal for a plant based on the expected time of operation for the plant.

More particularly, the system receives inputs from a user, according to goals and objectives defined by management of an enterprise, or which may be defined in an automated fashion. The goals or objectives may be dynamic, i.e., may change from hour to hour or day to day for any resource or combination of resources. For example, a goal may be to have equipment run for 30 days if a plant owner is selling a company or the goal may be to have equipment run for 910 days with the lowest cost to the enterprise. As another example, when using human resources the goal may be to redeploy the lowest skill level employees to the jobs for which they are suited to arrive at optimum human resource efficiency. The inputs received are sent to a resource attributes and characteristics identifier 3008.

The resource attributes and characteristics identifier 3008 allows a user to input and store the attributes and characteristics of human, operating and manufacturing resources. This information may be obtained, for example from an enterprise resource planning system, etc., as indicated at 3010. Data from the resource characteristic database N and the enterprise resource database O also may be used, as indicated at 3012.

For example, the resource attributes and characteristics identifier 3008 may include a product decoder and standard data converter to transform part numbers into specific information about a product. A resource rating system allows for input of the skill level for each human resource and a skill level required for each product. A generic attribute and characteristic identifier allows for input of general information such as grades of material that are available for a product.

Finally, an actual characteristic and attribute identifier provides a checklist to a user to allow for input of information about what the operator measures, sees, smells, tastes, hears or touches about, or what is mechanically sensed, e.g., using a transducer, from each resource subject to the resource management system in the enterprise. This information may be historical, to allow resource conditions, changes and trends to be followed. Thus, this information specifies the actual characteristic of the resource, not its specified characteristic. For each of a plurality of human resources in an enterprise, a skill level of the human resource may be stored, over time, for example. Skill levels may change in human resources through training, equipment condition changes over use, and manufacturing resources changes that are consumed. These changes may be recorded over time.

When the resource is equipment, the actual conditions of equipment could, for example, be entered using a hand held computer by an individual in the field, or may be entered automatically through measurement equipment, such as a scanning device for measure dimensions. Conditions also may be detected using equipment or may be detected by using human operators.

The data received and generated by the identifier 3008, as indicated at 3014, are stored in the user database L, enterprise resource database O and enterprise performance database P, as appropriate, as indicated at 3016.

More particularly, the resource attributes and characteristics identifier receives a request for a purchase, analysis or simulation for one or more resources with the associated corporate goals and objectives defined. It first decodes any nonstandard information into a standard format using the data converter. Then it identifies the human resource skill level available at the plant, which may be identified by plant personnel, such as a training department or human resources department, etc. It identifies the human resource requirement for each resource, such as the skill required for installation of a seal. Such information may be supplied by product manufacturers or those knowledgeable in the field. The resource attributes and characteristics identifier then identifies all resources which impact or are impacted by the resource in question. The characteristics are grids which vary by product or service or resource whose architecture is a universal standard by product, by industry, etc. This information is typically supplied by those knowledgeable in the field to populate the database with identification of attributes and/or characteristics of all resources of interest.

With information about the resources in the database, a resource characteristics interaction identifier 3018 may be used to specify the impact of one resource on another resource, to help identify and define deficiencies in predictions, decisions and actions. For example, the seal specifier and compatibility analyzer from the ESP application, indicated as database Q at 3020 may be used by this identifier 3018. Information from the deficiency database M and the resource characteristic database N also may be used, as shown at 3022. This identifier enables a user to identify and make decisions about resource interactions to meet the defined goals and objectives of the enterprise. This identifier also may make decisions automatically without the need for user action. Using this identifier, the most efficient combination of all of the resources may be identified. Further, decisions about buying, operating, using and selling one of these resources can be tied directly to some quantifiable difference between the ideal solution for meeting the stated goals and objectives and some other solution. For example, an increasing or decreasing mean time between failure may be used to drive life cycle cost calculations.

Resource life, which may be defined, for example, in hours, days, etc., or a percentage of decreased life is identified from resource characteristics in combination from the grids and checklists that are populated by those knowledgeable in the field, and/or enterprise resource planning systems and inputs from front line workers. By combining real world inputs, e.g., the resource characteristics, with these other inputs, outcomes regarding a resource may be predicted. Best in class attributes and characteristics are identified typically by those knowledgeable in the field. The resource attributes and/or characteristics are identified that are deficient alone and in combination compared to best in class attributes and/or characteristics. Individual characteristics and/or attributes of actual or proposed resources, both alone and in combination with other resources, are compared to individual characteristics and/or attributes of “best-in-class” resources that are alone and in combination. From this comparison, resource life or a percentage of decreased life is identified for every characteristic/attribute.

The results 3024 from the identifier 3018 are stored in the user database L, enterprise resource database O and enterprise performance database P, as appropriate, as indicated at 3026. Specifications for resources to be purchased 3028 are stored and sent to an ideal solution definer, described in more detail below. The results from the identifier 3018 are provided in turn to a product life identifier 3032 which will now be described.

The product life identifier 3032 performs a “resource life” calculation for a resource resulting from the cumulative effect of predictions, decisions and actions regarding resources by which it is impacted and which it impacts. For example, the product life identifier may compute a mean time between failure estimate for an operating resource. It uses data, including predictions from the deficiency database M and the resource characteristic database N as indicated at 3040. The result is an estimated resource life 3042 which can be stored in the enterprise resource database O and enterprise performance database P as indicated at 3044, and can be used to update the deficiency database M. The resource life also may be used in an LCC analysis as indicated at 3033. It should be noted that the estimated resource life 3042 is in itself a prediction of this system which may be tracked for deficiencies over time by comparing the estimated resource life to the actual resource life. For example, if a particular product has a known deficiency in combination with other resources, and the impact of this deficiency on product life is known, an estimate of the product life can be quantified. For example, as shown above in FIG. 5B, if a particular casing is inferior for temperature control, then there can be a quantifiable measure of impact on the life of the product.

For example, the product life identifier may use predictions from those knowledgeable in the field for a resource alone or for resources in combination. The stored predictions may be changed by a user, and such changes may be tracked to allow for accountability for the change. The prediction may indicate an estimated life or a percentage decrease in life with respect to the expected life of the resource, or with respect to a hypothetical best in class resource. Outputs from resource characteristics interaction identifier 3018 are combined (using both individual resource life or percentage of decreased life) for each characteristic and/or attribute, and are totaled. Resources are assigned a predetermined life estimate along with a best in class estimate (MTBF) for each resource. This calculation is performed for each resource which impacts or is impacted by any decision.

These calculations assist in making repair/rebuild decisions. As an example, if a system had one part with an expected life of 2000 hours and another part with an expected life of 1980 hours, both parts might be replaced at 1980 hours. Such decisions generally are not made scientifically. The expected life might be determined based on laboratory conditions and not real world conditions. The laboratory conditions do not take into account the interactions of other actual resources in the enterprise. The information stored that identifies deficiencies by comparing actual conditions to ideal conditions is used to predict more accurately the expected life of a resource in actual conditions in the enterprise, enabling better decision making about rebuilding, repair and maintenance scheduling. Such decisions may otherwise be deficient by replacing parts earlier than required or by waiting too long and having a failure occur.

An efficiency analyzer 3030 uses efficiency data from the deficiency database M and the resource characteristic database N, as indicated at 3032, to analyze the impact of deficiencies in decisions about various resources for the resources which are being analyzed. It also may compare an enterprise with other enterprises. The efficiency results are returned at 3034 and may be stored in the user database L, enterprise resource database O and enterprise performance database P and may update the deficiency database M, as indicated at 3036. The efficiency results also may be used to re-evaluate goals and objectives or to make later decisions as indicated at 3038. The efficiency analyzer thus enables an enterprise to determine how efficient it is with respect to an existing definition of the best in class and enables a quantification of that difference. These deficiencies are not only physical conditions but also may include predictions, decisions and actions, such as workmanship, regarding any resource. Results also may go to the accountability analyzer as indicated at 3037.

The efficiency analyzer 3030 receives the outputs from the product life identifier and compares the estimated life of the resource with the goals and objectives of the organization. In particular, for each deficiency of each resource, a cost impact of the deficiency may be stored. This cost impact and the estimated life of the resource are compared to the stated goals and objectives. If these are not compatible, e.g., goal of 200 days with no downtime and the estimated life is 100 days, a deficiency is noted. For example, if a seal being used from the storeroom is analyzed and it does not meet the goals and objectives of the enterprise then a deficiency is identified, exposed, and stored for later use. Thus, deficient decisions may be identified when they do not meet corporate goals and objectives. Given a best in class definition of resources, a measure of the efficiency of the current resources may be obtained. A deficiency exists wherever the combination of resources is non optimal given the stated goals and objectives.

The deficiencies and change in resource life suggest a failure mode determined by a failure mode predictor 3046. This failure mode predictor may use data from the deficiency database M as indicated as 3048 to present pictorial graphics of anticipated failures, or engineering dimensional specifications, etc., as to the appearance and dimensions of the failure mode to enable validation by a front line worker. The predicted mode of failure then may be stored as indicated at 3047 and 3048. This data may be used by a failure analyzer after a failure occurs, as will be described in more detail below.

The failure mode predictor assigns the graphic or dimensional mode of failure to be expected given a deficiency in a resource. The expected mode of failure may be stored as a prediction of one knowledgeable in the field associated with the deficiency of the resource. Results are fed to deficiency identifier/analyzer and are stored for use by the failure analyzer. Thus, for a pump if the seal o-ring is the first item that will fail on a pump, this expected failure mode is identified by the failure mode predictor from the database.

With this information, predictions (made by those knowledgeable in the field) are combined with information about actual conditions (such as provided by front line workers using checklists and/or through machine inputs) to predict “equipment life” (MTBF) and provide failure modes and graphics associated with the likely mode of failure at the end of the equipment life. For example, if the expected failure date for a seal (typically the first mode of failure in a pump) was 196 days, then the expected time frame along with the failure mode appearance graphics are stored for that combination of pump and seal and operating conditions. If the actual conditions specify that pump, seal and operating conditions, this estimate of equipment lifetime is retrieved from the database and the expected failure mode may be shown to a user.

If actual failure dates do not coincide with predicted failure dates the results are “deficiencies”. For example, if the actual life is 310 days and the product life identifier suggests that the expected life was 196 days, then there is a deficiency, for example, in the prediction itself or in a checklist that may have been filled in incorrectly by frontline workers who, for example, may have measured something incorrectly or recorded a worse equipment condition than what actually existed.

Because the expected failure mode and time frames are stored in association with a specified combination of resources, if the specified resources change, then the predictions automatically change for the enterprise as well. For example, if a pump is pumping acetone today and is changed to be pumping oil tomorrow the failure graphic associated with pumping acetone may be a “worn seal face” but for pumping oil may be a “swollen o-ring.” This system thus enables the failure mode and failure date to be retrieved for a specified combination of resources, and deficiencies to be identified if the expected date is not reached before a failure. If a failure does occur, or if the failure mode and data represent the outcome of a deficiency, then corrective actions may be provided to remedy the deficiencies, as described in more detail below. The failure graphics identified produce a short list of all possible predictions, decisions and actions which may have produced the deficiency along with checklists to quickly identify the deficiency. These check lists may for example instruct a user to measure face wear. Such actual measurements may be used to improve predictions.

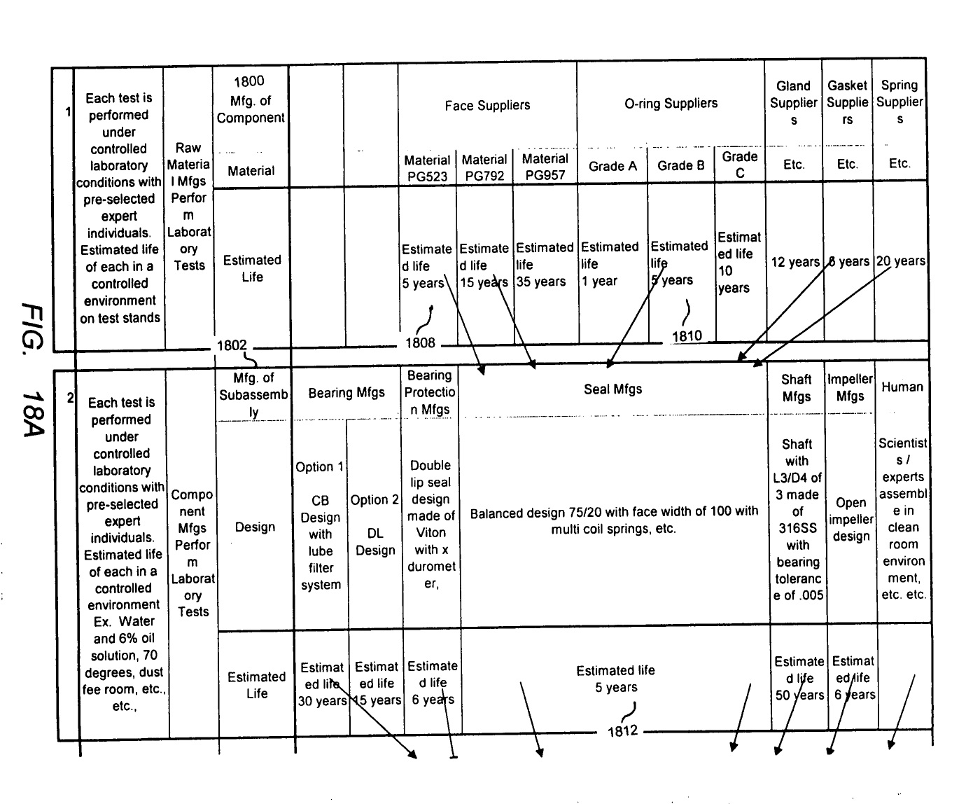

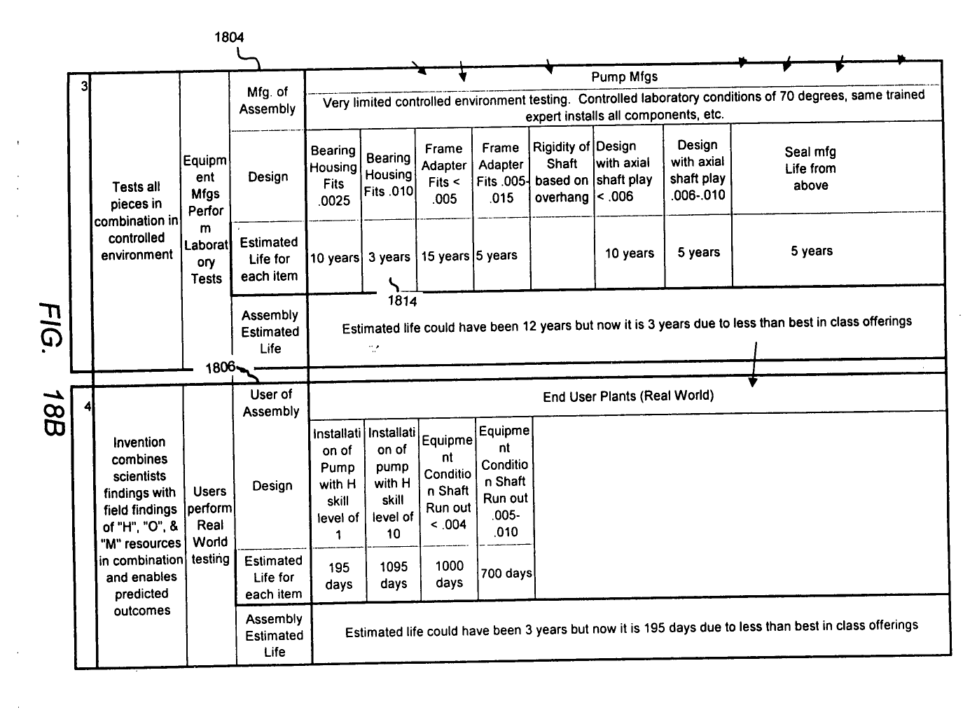

The product life identifier and failure mode predictor may be considered as one part of a system because of the interrelationship between the expected failure mode and the expected life of a resource. An example determination of a product life and failure mode will now be described in connection with FIGS. 18a-b. For example, combinations of technology, such as a component as indicated at 1800, a subassembly as indicated at 1802 and assembly as indicated at 1804 in combination with real world conditions as indicated at 1806. All have an impact on the estimated life, due to deficiencies in each of the component's subassembly's assemblies and actual use. For example, the estimated life of a seal may be five years due to the selected material for the face and the selected material for the o-ring, as indicated at 1808 and 1810. Thus, the estimated life of a subassembly is limited by the estimated life of the seal as indicated at 1812. This information could be obtained through controlled laboratory tests. The estimated life of the assembly in the pump is limited to three years as indicated at 1814, due to the use of inferior goods. In actual use then this resource is then combined with other resources in an enterprise. For example, changes in the operating conditions of the subassembly may cause various failures. For example, the installation of the pump with a low level skill in the work force could significantly limit the lifetime of the pump. Thus, in this example, the combination of information about the resources and their expected lifetimes results in a lifetime of 195 days due to deficiencies in the skill level for installation, the bearing housing, and the grade of material for the face and the o-ring in the seal.

A deficiency identifier and analyzer 3050 in general identifies deficiencies in the predictions, decisions and actions made in connection with the resources. This identifier may be utilized at any time using the data from the various databases or after a failure. For example, a deficiency in a prediction may be quantified by a comparison of an increased or decreased mean time between failure, or a life cycle cost, between the prediction and the actual outcome. Similar defects in actions and decisions may be identified. For example, each decision made by this system may be stored and compared to an outcome. The identified deficiencies may be applied to an LCC analysis, or other financial analysis, as described below, to measure the financial impact of the deficiencies and predictions, decisions and actions as indicated at 3052. The identified deficiencies, also as indicated at 3054 are stored in the enterprise resource database O and enterprise performance database P, and may be used to update the deficiency database M as indicated at 3056.

More particularly, the deficiency identifier 3050 may use the results of the product life identifier, which is the number of days of life to be expected (such as may be defined by an MTBF calculation), and the results of the failure mode predictor, which is an indication of the actual graphical depiction or dimensional value or other perceivable or measurable characteristic of an item, e.g., a failure mode of a seal, that should appear when the item fails. When a failure occurs, the number of days from product life identifier and the graphic or dimension from failure mode predictor are compared to the actual failure date and appearance or dimension from the failure analyzer, which may be identified by front line workers, for example by using graphics and checklists. If the failure occurs on the date predicted and the failure mode matches then there are no deficiencies in predictions, decisions and actions because the actual outcome equals the results expected. If the graphics or dimensions or other indicators of the failure mode and dates do not match, the results from the failure analyzer, which may be used by front line workers using pictorial graphics, indicate the actual cause of failure. This analysis indicates that there was at least one deficiency in either predictions, decisions, or actions with respect to this item. These findings are stored to help fine tune future predictions, decisions and actions. The deficiency analyzer also may store the difference in time to enable measurement of the financial impact the deficiency has on the operation.

Using the identified deficiencies, a corrective actions specifier 3058 specifies corrective actions for these deficiencies, as obtained from the deficiency database M as indicated at 3060. The corrective actions are specified as indicated at 3062 and stored in the enterprise resource database O and the enterprise performance database P at 3064, as appropriate, in addition to being communicated to individuals or systems to perform the corrected actions. In particular, corrective actions may be specified by those knowledgeable in the field and stored in the database for each deficiency. Given each deficiency that is identified by the deficiency identifier, the corrective actions for each deficiency are retrieved from the database and may be provided to a worker for execution, or may be identified to management for a decision to be made.

With the deficiencies identified, and corrective actions specified, or with deficiencies identified based on goals and objectives as indicated at 3037, an accountability assignor 3066 identifies human resources or other individuals or entities involved in the prediction, decision or action which resulted in the deficiency, both internally and externally to the enterprise. For example, an expert may be identified as accountable for an erroneous prediction. Decision makers may be identified as accountable for an erroneous decision. Other workers may be identified as accountable for errors in actions. Manufacturers may be identified as accountable for deficiencies in products. This assignment of accountability may be made by tracking, for each decision made in the system, an identity of a user making the prediction, decision or action stored in the database, and the identity of the source of a resource. The accountability for a failure or a deficiency may be assigned as indicated at 3068 and stored in the enterprise resource database O and the enterprise performance database P, as indicated at 3070.

An LCC or other financial cost analysis also may be performed as indicated at 3072. Many methods are known for computing a life cycle cost analysis and any suitable methodology may be used. The accuracy of the cost analysis depends on the accuracy of the cost model for the resource and the accuracy of the data used in the cost model. The cost model of the resource is determined in part by the interaction of the resource with other resources, as indicated above in the resource characteristic interaction identifier. The cost information may be obtained from user database L or from an enterprise resource planning system as indicated at 3074 or from the product life estimator as indicated at 3033. The estimated life cycle cost for a new resource or life cycle cost associated with a deficiency may be calculated and stored as indicated at 3076 and 3078. The LCC analysis also can be used to determine differences between predicted and actual performance. The results from the accountability assignor may be used to assign the cost of deficiencies to the responsible party.

For purchasing decisions or simulation of resources, the LCC cost information may be compared to the goals and objectives to determine if a proposed solution for a resource is acceptable. If the solution is acceptable as indicated at 3073, the solution may be purchased. If the solution is not acceptable, further solutions may be identified and analyzed using the system, until a solution is found that is acceptable in view of the goals and objectives, or the goals and objectives may change.

An ideal solution definer 3080 may be used to specify an ideal solution using the cost information, goals and constraints from user database L as indicated at 3082, information, such as the resource characteristics interaction information which has taken into account the goals and objectives, from the other databases O, P, M and N, indicated at 3084 and specifications 3086 for resources to be purchased, from which an ideal solution is defined, as indicated at 3088. This ideal solution may be a specified product or resource 3090 to be purchased. Information about this specified product may be stored in the user database L, enterprise resource database O, deficiency database M and the enterprise performance database P as indicated at 3092 and 3094. Given the information in the database and the goals and objectives of the enterprise, the ideal combination of resources that meets the goals and objectives can be readily selected from the database.

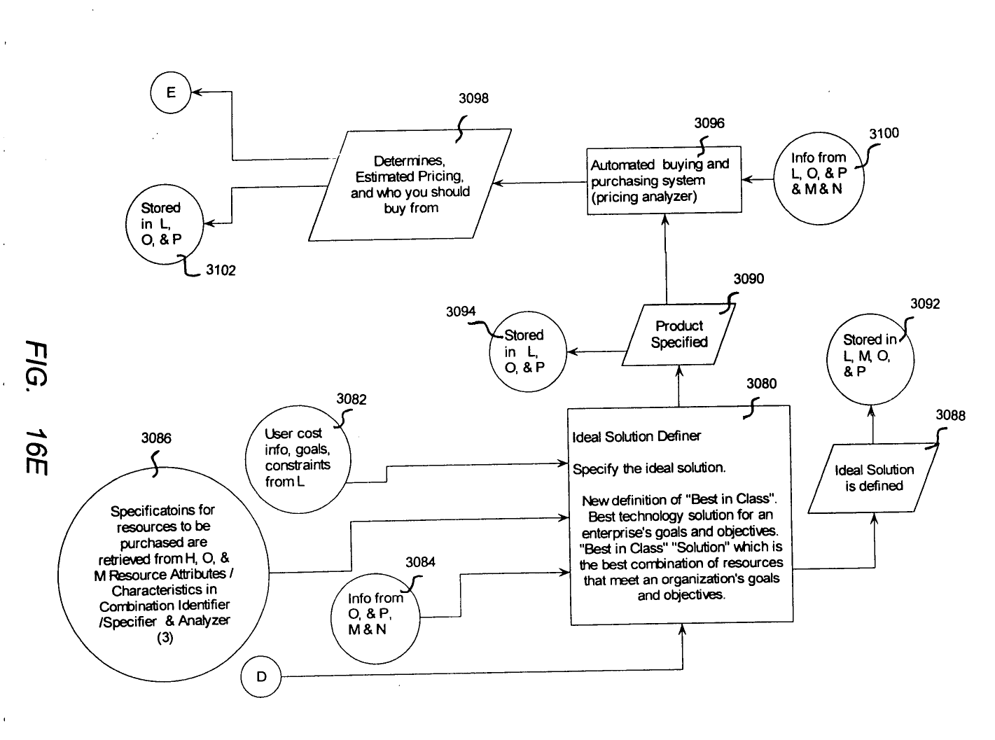

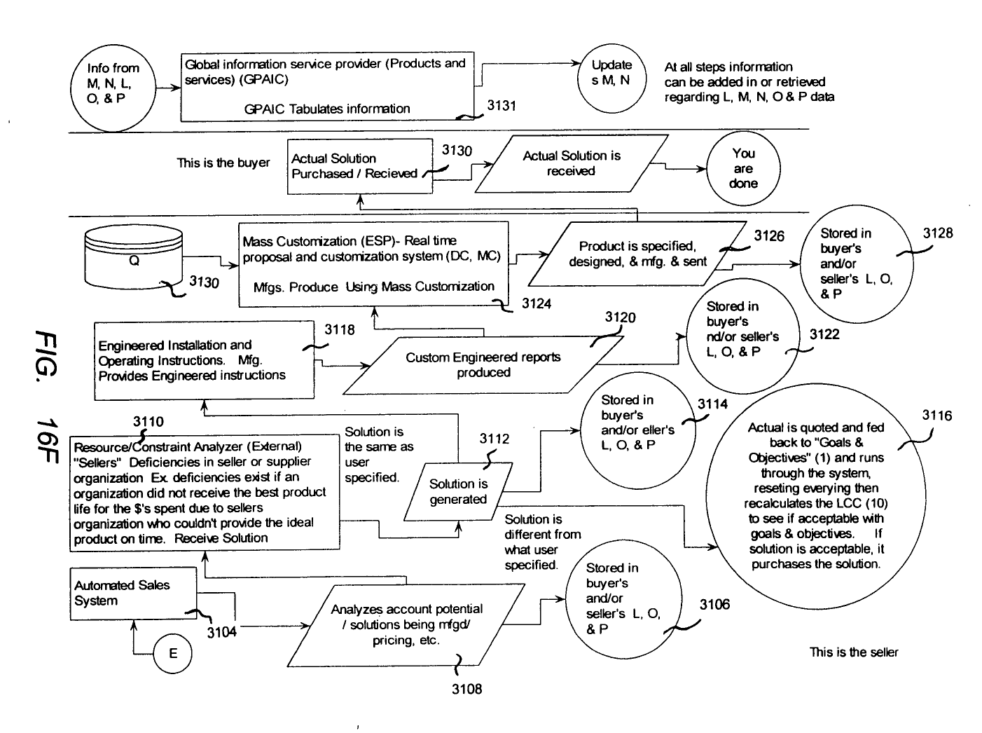

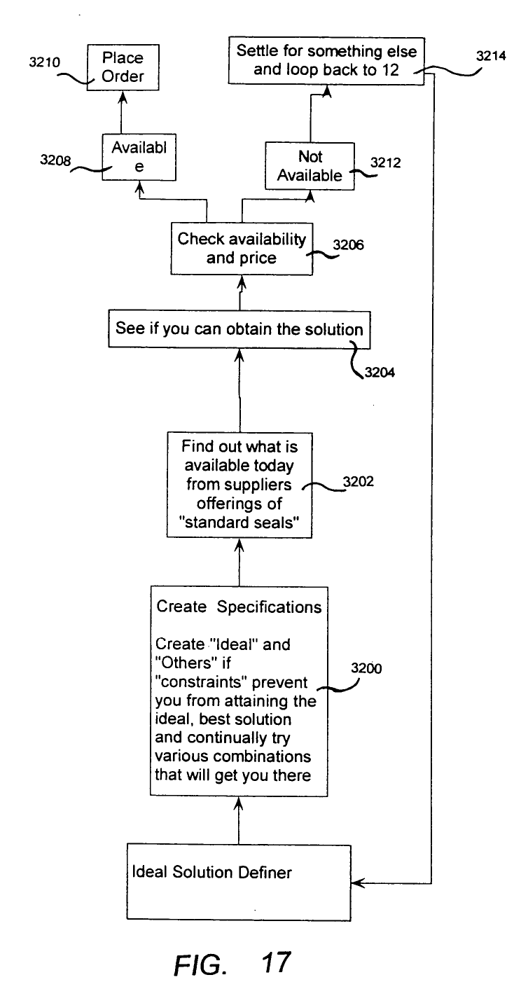

In one embodiment, shown in FIG. 17, the ideal solution allows an enterprise or individual to create specifications, as indicated at 3200 which would enable requests for quotes or other requests or searching to be performed to identify what is available from current suppliers or standard products as indicated at 3202. If the solution can be obtained, as indicated at 3204, at an appropriate availability and price, as indicated at 3206, the product may be available as indicated at 3208 and an order may be placed in step 3210. Otherwise the product is not available as indicated at 3212 and an individual or enterprise settles for something else as indicated at 3214 and specifies a new solution with a new constraint that the desired product is unavailable.

Alternatively, significant information about the market and pricing may be stored to enable an automated buying or purchasing system (a pricing analyzer) 3096 to determine, as indicated at 3098, an estimated pricing and supplier for the specified product, using the information stored in all of the databases and indicated at 3100. The decision regarding pricing and supplier may be stored in the databases indicated at 3102. This module may use stored information about manufacturer and resaler margins and distribution channels to determine the appropriate supplier and purchase price. This module may be pre-populated with such information from analysts or others knowledgeable in the field and may be continuously updated.

The automated buying and purchasing system 3096 may have a corresponding automated sales system 3104 at the seller of the corresponding resource. The seller may have access to the buyer's user database L, enterprise resource database O and enterprise performance database P to retrieve and store information as indicated at 3106. For example, the automated sales system 3104 may analyze account potential and pricing for the solutions being manufactured as indicated at 3108. The system may determine a price depending on the amount of knowledge available from the buyer or the remainder of the market. For example, by analyzing information about the cost structure of a purchaser of a resource and competitive pricing information (such as from competing manufacturers, their resellers, and their pricing and discount policies for different user sizes/industries) pricing, product, promotion and distribution policies may be determined automatically in real time.

The seller also may have its own corresponding system for managing their own resources. This resource constraint analyzer 3110 is used to generate a solution as indicated at 3112. The resource constraint analyzer compares the specification and pricing information to the seller's constraints to determine what solution can be provided. What a supplier can supply depends in part on the deficiencies of the suppler. The solution may be what the user has specified or may be different from what the user has specified. If it is the same, such information may be stored in the user database L, enterprise resource database O and enterprise performance database P as indicated at 3114. If the solution is different, the actual solution may be quoted and fed back to the buyer. A buyer may receive the information and recalculate all of the information, particularly the lifetime cost, of the proposed solution as indicated at 3116.

A seller also may create engineered installation and operating instructions as indicated at 3118 and produce custom engineering reports as indicated at 3120. This information may be stored in the user database L, enterprise resource database O and enterprise performance database P, as indicated at 3122, and combined to create the engineering installation and operating instructions based on the exact and complete specifications of the solution. In particular, the database may include a specific installation and operating instruction variant for each variant of a resource, such as an engineered product. Given the specification for the resource, such as an engineered product, the corresponding installation and operating instructions are retrieved and combined. The information used to complete these instructions may be created by those knowledgeable in the field then stored in the databases. A proposal generator in the ESP application is an example of such a module. A mass customization system then may be used to generate a real time proposal and customized product as indicated at 3124. An example of such a mass customization system as in the ESP application. Such a system receives an indication of resources with which an engineered product is to interact, determines compatibility of the product with the specified resources to specify the product, and manufactures the product so specified. The product then is specified, designed, manufactured and sent to the buyer as indicated at 3126 and information about it is stored in the databases as indicated at 3128. The buyer then has purchased and received the actual solution as indicated at 3130.

The engineered installation and operating instructions 3118, mass customization 3124 may be generated using a database 3130 as described in more detail in the ESP application, which is an example of an electronic sales system of FIG. 1.

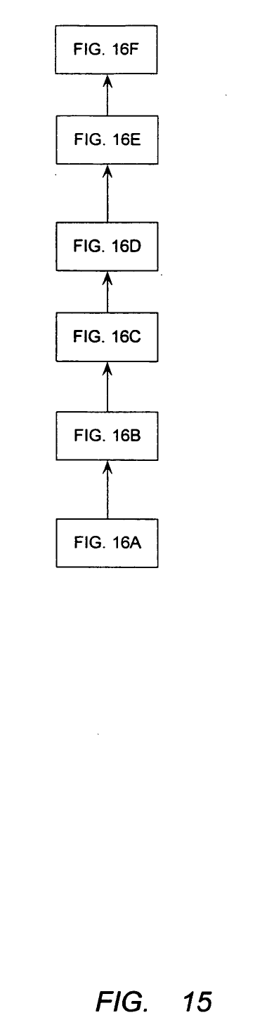

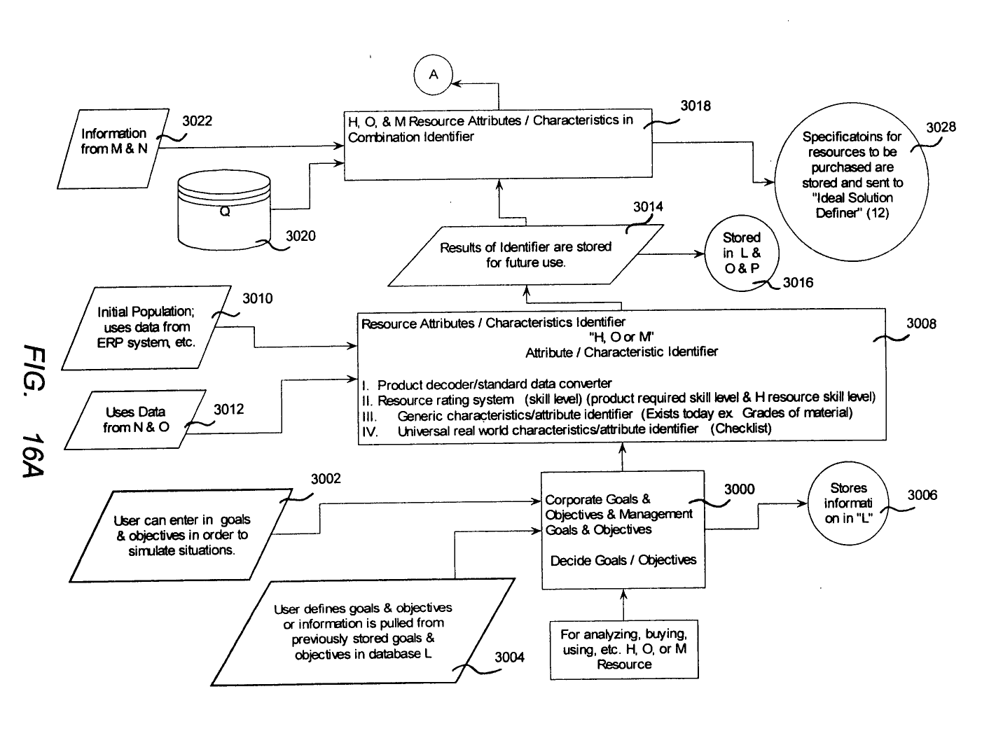

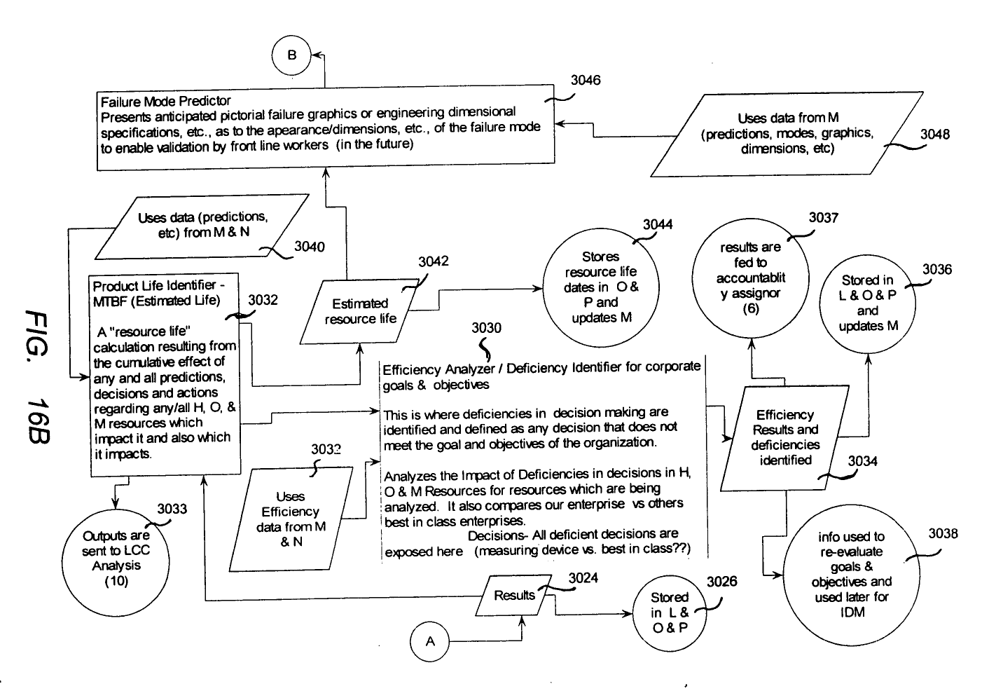

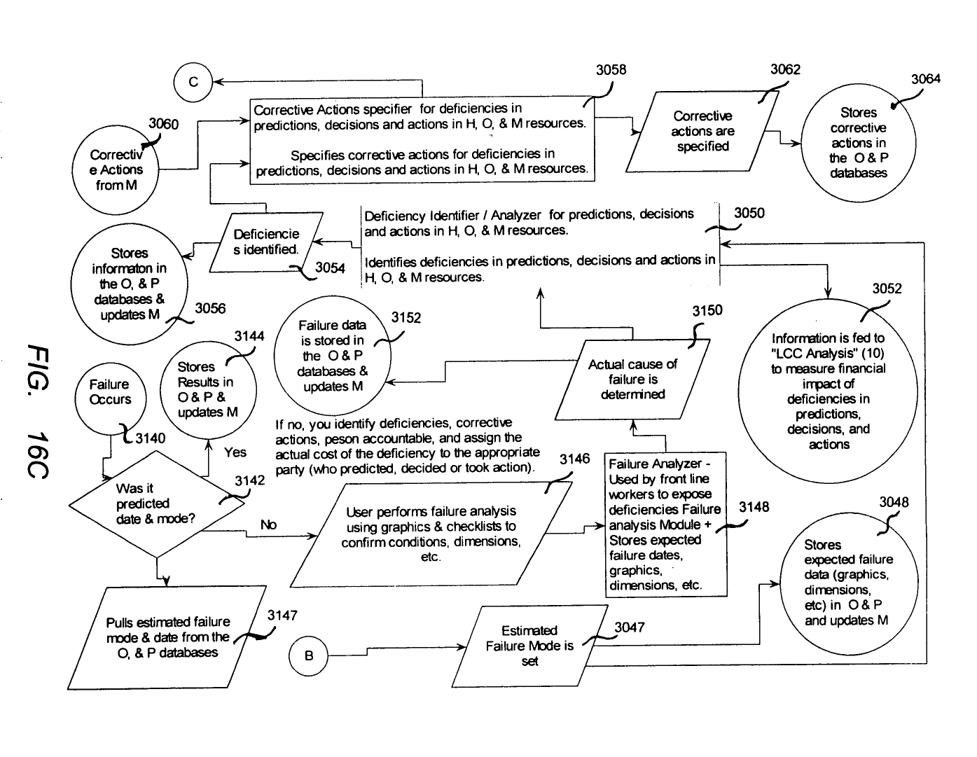

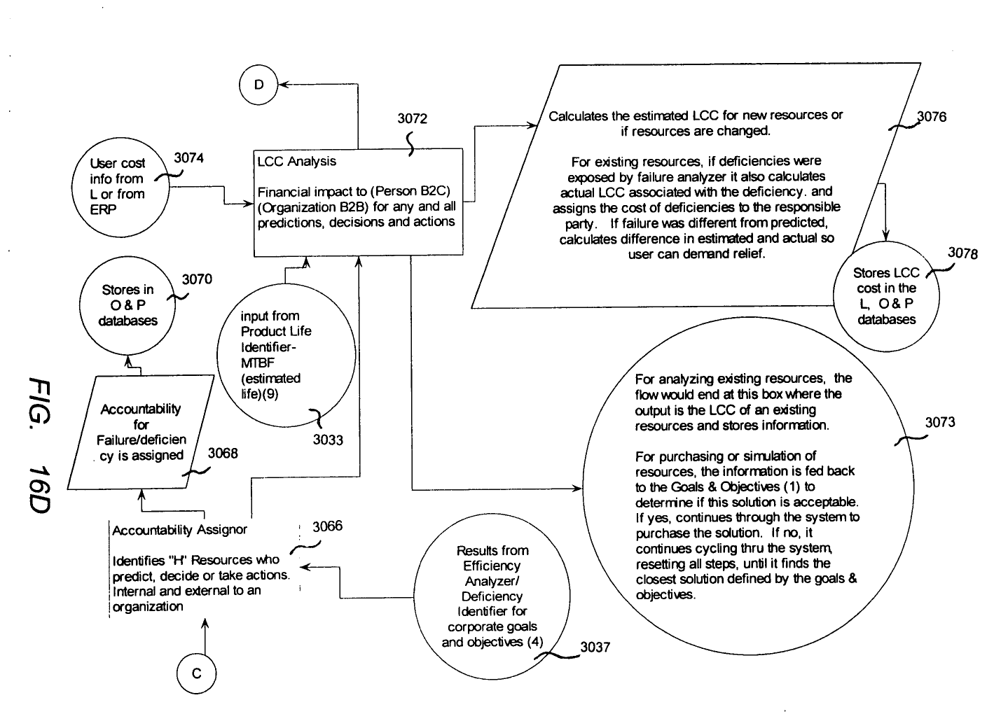

A global database of information 3131 may be created by aggregating information from buyers and sellers across a market for all of the user databases L, deficiency databases M, resource characteristic databases N, enterprise resource databases O and enterprise performance databases P. Each step in the process shown in FIGS. 16A-16F may store information in such a global service.

The foregoing process may be performed to specify resources to purchase or to specify resources to repair or to replace in an enterprise. The deficiency analyzer may indicate known and existing deficiencies in the currently used resources in the enterprise immediately upon population of the database. Other deficiencies may come to a user's attention when a failure occurs.

When a failure occurs, resources may need to be replaced or in some cases repaired. Referring to FIG. 16C, when a failure occurs, as shown at 3140, it is determined if the date and mode of failure corresponds to the predicted date and mode, pulled from the databases 3147, as indicated at 3142. If yes, the results are stored in the enterprise resource database O, enterprise performance database P and deficiency database M as indicated at 3144. If no, the user may perform failure analysis using graphics and checklists to confirm conditions, dimensions, etc. as indicated at 3146. A system for seals for performing such analysis is described in the Plant Reliability application. A failure analyzer as described in that application for seals, as indicated at 3148, determines an actual cause of failures indicated at 3150. This failure data is stored in the enterprise resource database O, enterprise performance database P and deficiency database M as indicated at 3152 and is provided to the deficiency analyzer 3050. The failure analyzer may be used to identify failures not only in operating resources such as seals but in any prediction, decision or action involving the buying, using, operating and selling of any human operating and manufacturing resource. The failure analyzer 3148 uses the results from the failure mode predictor. It also may store graphical/dimensional depictions or other information about resources to illustrate all failure modes associated with the resource. For example, every product has its own set of failure analyzer graphics. The failure graphics are used to display what the failure should look like at a given day so that if the actual and expected failures don't match, front line workers can identify the actual condition. Outputs are sent to the deficiency identifier.

With a system such as described above, various considerations may be made to improve the selection of a resource. For example, when hiring a human resource, the impact on all other resources and how the human resource is impacted by all other resources may be analyzed. If the individual's skill level is too low, the system identifies the percentage of decreased life to be expected for each resource.

As another example, when purchasing an operating resource, the impact on all other resources and how the operating resource is impacted by all other resources may be analyzed. For example, if a seal requires a high level of skill to install and the available human resources do not have the requisite skill level, the system identifies the percentage of decreased life to be expected for the operating resource. Thus, available skill level of a purchaser may be part of a request for quote to a supplier. Other deficiencies in resources at the purchaser also may be part of the request for quote.

As another example, when purchasing a manufacturing resource, the impact on all other resources and how the manufacturing resource is impacted by all other resources may be analyzed. For example, if an individual considers purchasing a lower grade material, then the impact of that lower grade material on other resources, such as equipment, is identified and the system identifies the percentage of decreased life for the equipment.

Thus, requests for quotes to suppliers also may specify the various conditions, i.e., the interactions with other resources, that are to be optimized by the resource provided by the supplier. To the extent that the supplier has access to the purchasers cost information, or has its own cost information based on the interactions of various resources, a better quote can be provided. Such information can be stored and aggregated from several suppliers and purchasers for a resource to enable better buying and selling decisions.

Computer systems for implementing the system described above as computer programs typically include main units connected to both output devices which display information to users and input devices which receive input from users. The main units generally include processors connected to memory systems via interconnection mechanisms. The input devices and output devices also are connected to the processors and memory systems via the interconnection mechanisms.

One or more output devices may be connected to the computers. Example output devices include a cathode ray tube (CRT) display, liquid crystal displays (LCD) and other video output devices, printers, communication devices such as a modem, storage devices such as a disk or tape, and audio output, one or more input devices may be connected to the computer system. Example input devices include a keyboard, keypad, track ball, mouse, pen and tablet, communication device, and data input devices such as audio and video capture devices. The invention is not limited to the particular input or output devices used in combination with the computer system or to those described herein.

Each one of the computers may be a general purpose computer system which is programmable using a computer programming language, such as C++, Java, or other language, such as a scripting language or assembly language. The computer system may also include specially programmed, special purpose hardware, or an application specific integrated circuit (ASIC). In a general purpose computer system, the processor is typically a commercially available processor, of which the series x86, Celeron, and Pentium processors, available from Intel, and similar devices from AMD and Cyrix, the 680X0 series microprocessors available from Motorola, the PowerPC microprocessor from IBM, the Alpha-series processors from Digital Equipment Corporation, and the MIPS microprocessor from MIPS Technologies are examples. Many other processors are available. Such a microprocessor executes a program called an operating system, of which windows family of operating systems including Windows NT, and Windows 95 or 98, Linux, UNIX, IRIX, DOS, VMS MAC OS and OS8 are examples, which controls the execution of other computer programs and provides scheduling, debugging, input/output control, accounting, compilation, storage assignment, data management and memory management, and communication control and related services. The processor and operating system define a computer platform for which application programs in high-level programming languages are written.

A memory system typically includes a computer readable and writeable nonvolatile recording medium, of which a magnetic disk, a flash memory CD-ROM (rewriteable), and tape are examples. The magnetic disk may be removable, known as a floppy disk, or permanent, known as a hard drive. A magnetic disk has a number of tracks in which signals are stored, typically in binary form, i.e., a form interpreted as a sequence of one and zeros. Such signals may define an application program to be executed by the microprocessor, or information stored on the disk to be processed by the application program. Typically, in operation, the processor causes data to be read from the nonvolatile recording medium into an integrated circuit memory element, which is typically a volatile, random access memory such as a dynamic random access memory (DRAM) or static memory (SRAM). The integrated circuit memory element allows for faster access to the information by the processor than does the disk. The processor generally manipulates the data within the integrated circuit memory and then copies the data to the disk after processing is completed. A variety of mechanisms are known for managing data movement between the disk and the integrated circuit memory element, and the invention is not limited thereto. The invention is not limited to a particular memory system.

Various computer platforms, processors, or high-level programming languages can be used for implementation. Additionally, the computer system may be a multiprocessor computer system or may include multiple computers connected over a computer network. Each computer program module described here may be a separate module of a computer program, or may be a separate computer program. Such modules may be operable on separate computers. Data may be stored in a memory system or transmitted between computer systems. The plurality of computers or devices may be interconnected by a communication network, such as a public switched telephone network or other circuit switched network, or a packet switched network such as an Internet protocol (IP) network. The network may be wired or wireless, and may be public or private.

Such a system may be implemented in software or hardware or firmware, or any combination thereof. The various elements of the system, either individually or in combination may be implemented as a computer program product tangibly embodied in a machine-readable storage device for execution by a computer processor. Various steps of the process may be performed by a computer processor executing a program tangibly embodied on a computer-readable medium to perform functions by operating on input and generating output. Computer programming languages suitable for implementing such a system include procedural programming languages, object-oriented programming languages, and combinations of the two.

The invention is not limited to a particular computer platform, particular processor, or particular high-level programming language. Additionally, the computer system may be a multiprocessor computer system or may include multiple computers connected over a computer network.

Various databases may be any kind of database, including a relational database, object-oriented database, unstructured database or other database. Example relational databases include Oracle 8i from oracle Corporation of Redwood City, Calif., Informix Dynamic Server from Informix Software, Inc. of Menlo Park, Calif., DB2 from International Business Machines of Yorktown Heights, N.Y., and Access from Microsoft Corporation of Redmond, Wash. An example object-oriented database is ObjectStore from Object Design of Burlington, Mass. An example unstructured database is Notes from the Lotus Corporation, of Cambridge, Mass. A database also may be constructed using a flat file system, for example by using files with character-delimited fields, such as in early versions of dBASE, now known as Visual dBASE from Inprise Corp. of Scotts Valley, Calif., formerly Borland International Corp.. In one embodiment, the system may be implemented using script files developed using a File Maker Pro software application running on a Windows 98 operating system. The databases are implemented using database script files and the operations of the various modules also are implemented as scripts for accessing those data files.

Having now described a few embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

It is to be understood that while the invention has been described in conjunction with the detailed description thereof, the foregoing description is intended to illustrate and not limit the scope of the invention, which is defined, by the scope of the appended claims. Other aspects, advantages, and modifications are within the scope of the following claims.

What is claimed is:

1. A process, comprising the steps of:
providing a resource database including information about at least one of resources used in an enterprise and other resources;
providing a deficiency database including (i) deficiency information for each of a plurality of particular resources regarding a resource deficiency of one particular resource relative to an alternative resource, said resource deficiency comprising a differential representative of a comparison of at least one attribute of said one particular resource to an attribute of said alternative resource, and (ii) deficiency information regarding an interaction deficiency of one particular combination of resources relative to an alternative combination of resources, said interaction deficiency comprising a differential representative of a comparison of at least one attribute of interaction between resources of said one particular combination of resources to an attribute of interaction between resources of said alternative combination of resources; and
deriving, with use by a processor of deficiency information from the deficiency database and resource information from the resource database, information regarding effects of at least one of (i) effects of said resource deficiency on employment of said particular resource in the enterprise and (ii) effects of said interaction deficiency on employment of said particular combination of resources in the enterprise, the derived information usable for resource management.

2. A process as in claim 1, wherein the third step includes selecting the deriving of information regarding effects of said resource deficiency or the deriving of information regarding effects of said interaction deficiency.

3. A process as in claim 1, wherein the second step comprises providing a deficiency database including deficiency information regarding resource and interaction deficiencies of a least one of operating resources, manufacturing resources and human resources.

4. A process, comprising the steps of:
providing a resource database including information about resources used in an enterprise; and
providing a deficiency database including, for each of a plurality of particular resources, information regarding a deficiency of one particular resource relative to an alternative resource, said deficiency comprising a differential representative of a comparison of at least one attribute of said one particular resource to an attribute of said alternative resource; and
deriving, with use by a processor of deficiency information from the deficiency database and resource information from the resource database, information regarding effects of said deficiency on employment of said one particular resource in the enterprise, the derived information usable for resource management.

5. A process as in claim 4, wherein the second step comprises:
providing a deficiency database including information regarding a deficiency of a resource relating to at least one of resource attributes, characteristics, performance, life, cost, efficiency, failure modes, compatibility, life cycle cost and quality of construction.

6. A process as in claim 4, wherein the second step comprises:
providing a deficiency database including information regarding deficiencies for at least one of operating resources, manufacturing resources and human resources.

7. A process as in claim 4, wherein the second step comprises:
providing a deficiency database including information regarding cost impacts associated with deficiencies.

8. A process as in claim 4, wherein the third step comprises:
deriving information regarding effects of use of the one particular resource relative to an operating objective of the enterprise.

9. A process as in claim 4, wherein the second step comprises:
providing a deficiency database including information on a failure mode associated with the one particular resource.

10. A process as in claim 4, wherein the second step comprises:
providing a deficiency database including information on a life cycle cost estimate regarding the one particular resource.

11. A process as in claim 4, wherein the second step comprises:
providing a deficiency database including information on a mean time between failure deficiency regarding the one particular resource.

12. A process as in claim 4, wherein the third step comprises:
deriving information regarding a modification which, when made, enables the one particular resource to be compatible with a second resource.

13. A resource management system, comprising:
a resource database including information about resources used in an enterprise: and
a deficiency database including, for each of a plurality of particular resources, information regarding a deficiency of one particular resource relative to an alternative resource, said deficiency comprising a differential representative of a comparison of at least one attribute of said one particular resource to an attribute of said alternative resource; and
a processor coupled to the deficiency database and resource database and arranged to use deficiency information from the deficiency database and resource information from the resource database to provide information regarding effects of said deficiency on employment of said one particular resource in the enterprise, the derived information usable for resource management.

14. A resource management system as in claim 13, wherein said deficiency database includes information regarding a deficiency of a resource relating to at least one of resource attributes, characteristics, performance, life, cost, efficiency, failure modes, compatibility, life cycle cost and quality of construction.

15. A resource management system as in claim 13, wherein said deficiency database includes information regarding deficiencies relating to interactions among resources and the processor is arranged to provide information regarding effects of said deficiencies relating to interactions among resources upon operations of the enterprise.

16. A resource management system as in claim 13, wherein said deficiency database includes information regarding deficiencies for at least one of operating resources, manufacturing resources and human resources.

17. A resource management system as in claim 13, further comprising:
a storage unit coupled to said processor and arranged to store the deficiency database and the resource database.

18. A resource management system as in claim 13, wherein said deficiency database includes information on cost impacts of deficiencies.

19. A resource management system as in claim 13, wherein said deficiency database includes information on a mean time between failure deficiency regarding the one particular product.

20. A resource management system as in claim 13, additionally comprising:
an efficiency analyzer, responsive to a value for the estimated life of a resource and to information regarding a deficiency of the resource, to provide a determination regarding effects of use of the one particular resource relative to an operating objective of the enterprise, said efficiency analyzer comprising the processor with suitable programming.

21. A resource management system as in claim 13, additionally comprising:
an enterprise performance database including information regarding human entities of the enterprise and predictions, decisions and actions of such entities: and
an accountability assignor coupled to the enterprise performance database and responsive to an indication of a deficiency to identify an entity responsible for a prediction, decision or action resulting in the deficiency, said accountability assignor comprising the processor with suitable programming.

22. A resource management system as in claim 13, additionally comprising:
a resource life estimator, responsive to a deficiency related to said one particular resource, to provide an estimate of the life of that resource, said resource life estimator comprising the processor with suitable programming.

23. A resource management system as in claim 13, additionally comprising:
a failure mode predictor, responsive to a deficiency related to said one particular resource, to identify a failure mode associated with that resource, said failure mode predictor comprising the processor with suitable programming.

24. A resource management system as in claim 13, wherein said deficiency database includes, for said one particular resource, display information relating to a failure mode corresponding to a failure of that resource, the system further comprising:
means for prompting a user, by use of said display information, to identify a failure mode by comparison of said display information to the failure of said one particular resource.

25. A resource management system as in claim 13, further comprising:
a deficiency identifier, responsive to an indication of a failure mode of said one particular resource, to identify at least one deficiency related to the indicated failure mode of that resource, said deficiency identifier comprising the processor with suitable programming.

26. A resource management system as in claim 13, wherein said deficiency database includes for said one particular resource information regarding at least one corrective action associated with a failure mode, and the system is responsive to an indication of a failure mode of that resource to identify at least one corrective action related to the failure mode.

27. A resource management system as in claim 13, additionally comprising:
a life cycle cost analyzer, responsive to a deficiency related to said one particular resource, to provide a life cycle cost estimate regarding that resource and said deficiency, said life cycle cost analyzer comprising the processor with suitable programing.

28. A resource management system as in claim 13, additionally comprising:
a competitive price database including competitive pricing information about resources; and
a pricing analyzer coupled to the competitive price database and responsive to information regarding said one particular resource to provide indication of a price for that resource, said pricing analyzer comprising the processor with suitable programming.

29. A resource management system as in claim 13, additionally comprising:
a resource combination analyzer responsive to identification of an enterprise objective to determine a preferred combination of resources to meet the enterprise objective, said resource combination analyzer comprising the processor with suitable programming.

30. A resource management system as in claim 13, additionally comprising:
a resource specification database including information regarding manufactured resources; and
a resource specifier coupled to the resource specification database and responsive to identification of said one particular resource to provide a specification for that resource, said resource specifier comprising the processor with suitable programming.

31. A resource management system as in claim 13, additionally comprising:
a failure analyzer responsive to information on a failure of said one particular resource to identify possible causes of failure of that resource, said failure analyzer comprising the processor with suitable programming.

32. A process, comprising the steps of:
providing a resource database including information about at least one of resources used in an enterprise and other resources;
providing a deficiency database including information regarding a deficiency of one particular combination of resources relative to an alternative combination of resources, said deficiency comprising a differential representative of a comparison of at least one attribute of interaction between resources of said one particular combination of resources to an attribute of interaction between resources of said alternative combination of resources; and
deriving, with use of a processor of deficiency information from the deficiency database and resource information from the resource database, information regarding effects of said deficiency on employment of said particular combination of resources in the enterprise, the derived information usable for resource management.

33. A process as in claim 32, wherein the second step comprises:
providing a deficiency database including information regarding cost impacts associated with deficiencies.

34. A process as in claim 32, wherein the second step comprises:
providing a deficiency database including information regarding at least one failure mode associated with at least one deficiency related to interaction between resources.

35. A process as in claim 32, wherein the second step comprises:
providing a deficiency database including information regarding a failure mode associated with said one particular combination of resources.

36. A process as in claim 32, wherein the second step comprises:
providing a deficiency database including information on a mean time between failure deficiency regarding said one particular combination of resources.

37. A process as in claim 32, wherein the third step comprises:
deriving information regarding effects of said deficiency related to said one particular combination of resources upon operations of the enterprise.

38. A process as in claim 32, wherein the third step comprises:
deriving, with access to the deficiency database and resource database and responsive to identification of an enterprise objective, information regarding a preferred combination of resources to meet the enterprise objective.

39. A process as in claim 32, wherein the third step comprises:
deriving, with access to the deficiency database and resource database and responsive to characteristic of a first resource, information on a modification, which when made, enables a first resource to be compatible with a second resource to avoid a deficiency related to said one particular combination of resources.

40. A resource management system comprising:
a resource database including information about at least one of resources used in an enterprise and other resources:
a deficiency database including information regarding a deficiency of one particular combination of resources relative to an alternative combination of resources, said deficiency comprising a differential representative of a comparison of at least one attribute of interaction between resources of said one particular combination of resources to an attribute of interaction between resources of said alternative combination of resources; and
a processor coupled to the deficiency database and resource database and arranged to use deficiency information from the deficiency database and resource information from the resource database to provide information regarding effects of said deficiency on employment of said particular combination of resources in the enterprise, the derived information usable for resource management.

41. A resource management system as in claim 40, wherein said deficiency database includes information on cost impacts of deficiencies.

42. A resource management system as in claim 40, wherein said deficiency database includes information on a mean time between failure deficiency regarding said one particular combination of resources.

43. A resource management system as in claim 40, wherein the deficiency database includes information on at least one failure mode associated with at least one deficiency related to an interaction among resources, the system further comprising:
a failure mode predictor, coupled to the deficiency database and responsive to a deficiency related to an interaction between resources of said one particular combination of resources, to identify a failure mode associated with said interaction, said failure mode predictor comprising the processor with suitable programming.

44. A resource management system as in claim 40, further comprising:
a deficiency identifier, coupled to the deficiency database and responsive to identification of said one particular combination of resources, to identify deficiencies related to that combination of resources, said deficiency identifier comprising the processor with suitable programming.

45. A resource management system as in claim 40, further comprising:
a resource combination analyzer coupled to the deficiency database and resource database and responsive to identification of an enterprise objective to determine a preferred combination of resources to meet the enterprise objective, said resource combination analyzer comprising the processor with suitable programming.

46. A resource management system as in claim 40, further comprising:
a resource combination evaluator coupled to the deficiency database and resource database and responsive to identification of said one particular combination of resources to indicate deficiencies relating to that combination of resources, said resource combination evaluator comprising the processor with suitable programming.

47. A resource management system as in claim 40, further comprising:
a compatibility analyzer coupled to the deficiency database and resource database and responsive to characteristic of a first resource of said one particular combination of resources to determine a modification which, when made, enables the first resource to be compatible with a second resource, said compatibility analyzer comprising the processor with suitable programming.
